(19) United States
(12) Patent Application Publication
(10) Pub. No.: US 2008/0249658 A1
(43) Pub. Date: Oct. 9, 2008

(54) Products and Processes for Addressing a Customer Service Issue

(76) Inventors: Jay S. Walker, Ridgefield, CT (US); Paul T. Breitenbach, Wilton, CT (US); Daniel E. Tedesco, Shelton, CT (US); James A. Jorasch, New York, NY (US)

Correspondence Address: WALKER DIGITAL MANAGEMENT, LLC, 2 HIGH RIDGE PARK, STAMFORD, CT, 06905, US

(21) Appl. No.: 10/578,181

(22) PCT Filed: Jun. 16, 2005
(86) PCT No.: PCT/US05/21108

§ 371 Date: May 1, 2006

Related U.S. Application Data
(60) Provisional application No. 60/580,180, filed on Jun. 16, 2004.

(51) Int. Cl. G07F 11/00; G06F 17/00; G06Q 40/00

(52) U.S. Cl. 700/236; 700/232; 700/244

(57) ABSTRACT

According to an embodiment, a vending machine or other device receives, from a customer, a request for a product to be dispensed by a vending machine. It is determined that a customer service issue exists with the vending machine. It is also determined whether to provide a resolution to the customer service issue, and the resolution is provided to the vending machine customer.

### BRIEF DESCRIPTION OF THE FIGURES

FIG. 1 is a block diagram of an embodiment of a vending machine.

FIG. 2A is a block diagram of an embodiment of a system.

FIG. 2B is a block diagram of an embodiment of another system.

FIG. 2C is a block diagram of an embodiment of yet another system.

FIG. 3 is a diagram illustrating an example of the external appearance of a vending machine.

FIGS. 4A and 4B are a table illustrating an example data structure of an example transaction database.

FIGS. 5A and 5B are a table illustrating an example data structure of an example product inventory database.

FIG. 6 is a table illustrating an example data structure of an example coin inventory database.

FIG. 7 is a table illustrating an example data structure of an example resolution rules database.

FIG. 8 is a table illustrating an example data structure of an example customer service issue database.

FIG. 9 is a flow diagram illustrating an embodiment of a process.

FIG. 10 is a flow diagram illustrating an embodiment of a process.

### DETAILED DESCRIPTION

### Terms

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) embodiments of the disclosed invention(s)”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Similarly, where more than one device or article is described herein (whether or not they cooperate), a single device/article may alternatively be used in place of the more than one device or article that is described.

The functionality and/or the features of a device that is described may be alternatively embodied by one or more other devices which are not explicitly described as having such functionality/features. Thus, other embodiments need not include the described device itself.

### Disclosed Examples are not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s).

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

### Determination

“Determining” something can be performed in a variety of manners and therefore the term “determining” (and like terms) includes calculating, computing, deriving, looking up (e.g., in a table, database or data structure), ascertaining and the like.

### Computing

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications which claim the benefit of priority of the present application.

Certain embodiments of the present invention facilitate, among other things, the resolution of vending machine customer service issues by permitting potentially dissatisfied vending machines customers to register complaints, thereby allowing complaints to be addressed (e.g., by a vending machine, a computer or a human operator associated therewith). Such embodiments can therefore increase customer satisfaction with vending machines.

In certain “real time customer service” embodiments, a potentially-dissatisfied vending machine customer may obtain a resolution to a customer service issue (e.g. a machine malfunction) at substantially the same time as, or soon after, the attempted transaction by the customer. For example, a customer may report a malfunction (to a human operator, a vending machine, or a computer associated therewith). The malfunction may in turn be confirmed and/or recorded, and recourse (e.g. a refund) may be provided to the customer, thereby alleviating the customers potential dissatisfaction before the customer walks away from the vending machine.

In certain “asynchronous customer service” embodiments, a potentially-dissatisfied vending machine customer may register a customer service issue (e.g. a machine malfunction) with a vending machine or a computer associated therewith. After sufficient time for the issue to be identified and confirmed (e.g., by a human operator and/or a computer), a resolution (e.g. a refund) of the customer service issue may be provided to the customer.

### DEFINITIONS

Actual product velocity—The actual rate at which a given product is sold by a vending machine during a period of time (e.g., during a sales period). The actual product velocity may be expressed in many different types of units, such as dollars per time, units per time, products per time, etc.
Coin conservation—The practice of managing the working capital/available capital that is stored in, or otherwise available to be dispensed by, a vending machine. In an embodiment, coin conservation includes the practice of managing an available inventory of coins or other currency in order to provide refunds to customers as deemed appropriate, while also reserving or preserving a minimum amount of currency that can be used to provide customers with change as deemed appropriate. In an embodiment, a vending machine can engage in coin conservation by configuring and outputting one or more offers for one or more substitute products as a resolution, instead of providing a refund to a customer (e.g., to a customer who has not received a requested product due to a machine malfunction). Thus, where a forecast based on current sales patterns indicates that an insufficient number of coins remains in the machine to make correct change for every anticipated transaction throughout the remainder of a fill period, a vending machine control system may engage in coin conservation by providing (actually or potentially dissatisfied) customers with resolutions to customer service issues in which one or more products are offered, instead of refunds being provided. By conserving coins in this manner, vending machines may reduce or eliminate the number of events where “correct change only” is required of a customer, and thereby not lose certain potential sales from future customers who may not be able to tender exact change.
Compensation Code, Refund Code—An identifier or other token provided to a customer of a vending machine, typically pursuant to a resolution. In some embodiments, compensation codes may comprise alphanumeric codes and/or machine-readable indicia (e.g. barcodes, infrared signals, RFID transmissions) which are output by and/or transmitted to a vending machine, a computer associated therewith, and/or a user device. In some embodiments, compensation codes enable customers to (i) receive a refund amount immediately from a first machine, (ii) receive a refund amount immediately from a second machine, (iii) receive an amount (e.g. a refund amount, a refund amount plus an additional amount) from one or more machines at a future time (e.g. the next day), (iv) receive a credit to an existing account (e.g. a credit to a prepaid unit or “subscription” account, such as an extra snack or soda unit; a monetary credit to a financial account, such as a stored value account) and/or (v) receive a product (e.g. the initially requested product and/or a different, substitute product) from a vending machine. In some embodiments, compensation codes instruct a vending machine control system to entirely disable the advertisement and/or sale of certain products (e.g., unavailable products) so that future customers within a sales period are not disappointed. For example, where a customer seeks a refund after a bag of Doritos® chips fails to dispense, a customer may receive a refund code from a web site which instructs the vending machine to provide the customer with a refund, remove the Doritos® chips icon from a display screen (e.g., where the Doritos® chips are advertised), and disable any further attempted purchases of Doritos® chips until an operator can service or resupply the vending machine (e.g. at the end of a fill period).
Customer Service Representative, CSR—In some embodiments, a human associated with a vending machine operator (e.g. an employee thereof or third-party agent thereof) who receives diagnostic data, determines a resolution, and/or communicates the resolution to a vending machine customer.
Diagnostics, Diagnostic Data, Machine State Data, Machine Status, Customer Service Issue Data—Information associated with the operation of a vending machine which is used to determine whether a resolution should be provided to a vending machine customer.
Fill Period, Sales Period—The period of time between restock dates and/or restock times.
Full Price, Retail Price—In some embodiments, the price normally charged for the purchase of one unit of a given product.
Ideal product velocity, Target product velocity, Target velocity—The desired rate or rates at which a given product should be sold by a vending machine during a period of time (e.g., during a sales period). In some embodiments, an ideal velocity may be set, calculated or otherwise determined for each product such that the rate at which products are be sold would deplete the inventory to a certain level (e.g., to no inventory) by the end of a given sales period (i.e., by the next restocking event at the vending machine).

For example, an ideal product velocity for a product may be calculated by a vending machine control system after an operator inputs a restock date and a desired remaining inventory for the date. For example, an operator may wish to have only one unit of each product remaining at the next restocking event so that the vending machine sells as many products as possible without completely “selling out” and thereby disappointing customers who would want to purchase a sold out product. Thus, in the preceding example, if an operator (a) stocks 50 units of Soda A, (b) inputs a restock date fourteen days away, and (c) indicates that only one unit of Soda A should remain at the restock date, the control system may, e.g., divide 49 by 14 to conclude that, on average, 3.5 units must be sold per day during the sales period as the ideal product velocity.

As discussed herein, a vending machine or other device may (periodically, substantially continuously, or otherwise) determine whether or not actual product velocity of a product is at least equal to the Ideal product velocity, and if not, may attempt to increase product velocity of the product by, e.g., offering resolutions that provide potentially dissatisfied customers with that product rather than refund amounts.

Issue, Customer Service Issue, Complaint—An unresolved matter related to the performance of a vending machine which is related to a customer's actual or potential dissatisfaction. Customer service issues typically arise when a vending machine malfunctions (e.g., fails to dispense a requested product, dispenses a product that the customer did not request, or fails to process payment appropriately due to coin jams, bill validator problems). A customer service issue may be unrelated to a transaction of the customer (e.g., a vending machine malfunction that does not involve the customers transaction, the vending machine is dirty). A customer service issue may include a “bug” or other unintended features of the vending machine that may or may not qualify as malfunctions.
Operator—The owner (or agent thereof) of a vending machine. In one or more embodiments, an operator is a “route driver” or other service person who services one or more vending machines by restocking vending machines, removing or depositing currency in vending machines, and/or confirming the validity of outstanding customer service issues.
Product, Item—A good or service sold and/or dispensed by a vending machine. Examples of goods sold or dispensed by vending machines include beverages (e.g. cans of soda; bottles of water or iced tea) and snacks (e.g. candy bars; bags of chips). Examples of services sold or dispensed by vending machines include car washes, photography services and access to digital content (e.g. permitting the downloading of MP3 files or cellular telephone “ring tones” to a handheld device such as a cellular telephone or an iPod™ Portable digital electronic device by Apple Computer Inc.).
Resolution, Remedy, Recourse—Any benefit (e.g., a concession or compromise), or indication thereof, which can be offered and/or provided (e.g., on behalf of a vending machine operator) in an effort to satisfy a vending machine customer (e.g., a customer who is actually or potentially dissatisfied due to a customer service issue). For example, in an embodiment, a customer who has or reports a customer service issue is considered to be actually or potentially dissatisfied. In some embodiments, resolutions comprise tangible and/or intangible entitlements offered to a customer, for example, in lieu of an initially-requested product and/or a previously deposited amount of currency. Such tangible and/or intangible entitlements include substitute goods and/or services offered by a vending machine, money dispensed from a vending machine, monetary credit established in a credit balance (e.g. of a vending machine's payment processing apparatus which is tantamount to that amount of payment having been rendered to the vending machine), coupons for goods and/or services provided by a local retailer or another entity, and “compensation codes” (as defined herein). In some embodiments, the recourse that is provided to a customer may comprise an entitlement to receive a product that is typically sold by a retailer that is within the general proximity (e.g., within walking distance) of a vending machine. In such embodiments, a participating retailer may have a relationship with a vending machine operator to accept compensation codes as payment for such product(s), provided the vending machine operator subsequently reimburses the retailer for some or all of the cost or price of the product(s). Thus, in some embodiments, third party retailers may help resolve customer services issues.
Restock Date, Restock Time—The time and/or date that a vending machine is scheduled to be restocked by an operator (e.g. a route driver) of the vending machine.
User Device, Customer Device, Consumer Device—Any device owned or used by a customer, in which the device is capable of accessing and/or outputting (e.g., displaying) online and/or offline content. User devices may communicate with one or more vending machine servers or controllers, one or more vending machines, one or more third-party (e.g. retailer) servers, one or more user terminals (e.g. CSR terminals), and/or other network nodes. In some embodiments, user devices may, for example, include gaming devices, personal computers, personal digital assistants, personal music players (e.g. an MP3 player), point-of-sale terminals, point of display terminals, kiosks, conventional telephones, cellular telephones, automated teller machines (ATMs), pagers, and combinations of such devices.

### Vending Machine Apparatus and System Architecture

Generally, a vending machine may comprise a device, or communicate with a device (e.g., a server, a peripheral device, and/or a peripheral device server), that is configured to manage sales transactions with customers by, among other things, receiving payment from customers, controlling the pricing and/or distribution of products and/or controlling entitlements to products.

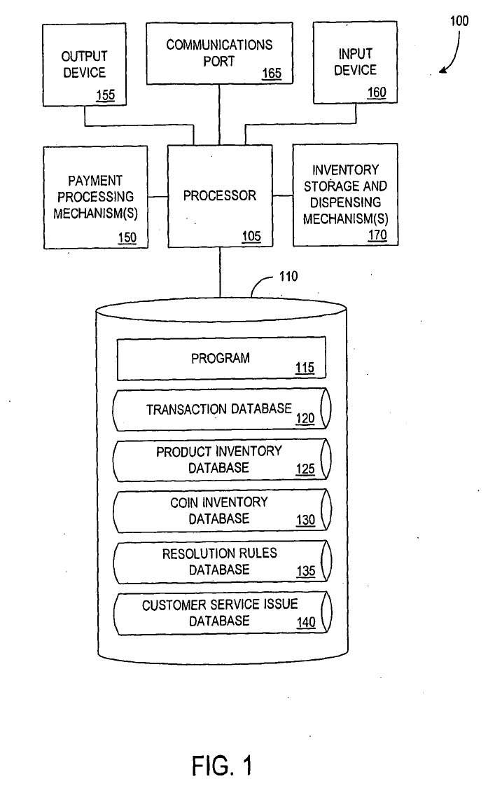

Referring now to FIG. 1, illustrated therein is a block diagram of an embodiment of a system. More specifically, FIG. 1 is a block diagram of an embodiment of a vending machine 100 that can be operable to perform one or more functions described herein.

The vending machine 100 may include a processor 105, such as one or more Intel® Pentium® or Centrino™ processors. The processor 105 (herein, “processor”, “processor 105”, “computer”, or “control system”) may include or be coupled to one or more clocks or timers and one or more communication ports 165 through which the processor 105 may, in accordance with some embodiments, communicate with other devices such as one or more peripheral devices, one or more servers, one or more peripheral device servers, and/or one or more user devices. The processor 105 is also in communication with a data storage device 110. The data storage device 110 may include any appropriate combination of magnetic, optical and/or semiconductor memory, and may include, for example, additional processors, communication ports, Random Access Memory (“RAM”), Read-Only Memory (“ROM”), a compact disc and/or a hard disk. The processor 105 and the storage device 110 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the vending machine 100 may comprise one or more computers (or processors 105) that are connected to a remote server computer operative to maintain databases, where the data storage device 110 is comprised of the combination of the remote server computer and the associated databases.

The data storage device 110 stores a program 115 for controlling the processor 105. The processor 105 performs instructions of the program 115, and thereby operates in accordance with the various embodiments, and particularly in accordance with methods of various embodiments described in detail herein. Various embodiments include a computer program 115 developed using an object oriented language that allows the modeling of complex systems with modular objects to create abstractions that are representative of real world, physical objects and their interrelationships. However, it would be understood by one of ordinary skill in the art that embodiments described herein can be implemented in many different ways using a wide range of programming techniques as well as general purpose hardware systems or dedicated controllers.

The program 115 may be stored in a compressed, uncompiled and/or encrypted format. The program 115 furthermore may include program elements that may be generally useful, such as an operating system, a database management system and device drivers for allowing the processor 105 to interface with computer peripheral devices. Appropriate general-purpose program elements are well known.

Further, the program 115 is operative to execute a number of objects, modules and/or subroutines, as disclosed herein.

According to some embodiments of the present invention, the instructions of the program 115 may be read into a main memory of the processor 105 from another computer-readable medium, such from a ROM to a RAM. Execution of sequences of the instructions in the program 115 causes processor 105 to perform the process steps described herein. In alternative embodiments, hard-wired circuitry or integrated circuits may be used in place of, or in combination with, software instructions for implementation of the processes of various embodiments. Thus, embodiments of the present invention are not limited to any specific combination of hardware, firmware, and/or software.

In addition to the program 115, the storage device 110 is also operative to store one or more databases, as described herein.

Vending machine 100 may comprise payment processing mechanism(s) 150. The payment processing mechanism(s) 150 may comprise one or more mechanisms for receiving payment and dispensing change, including a coin acceptor, a bill validator, a card reader (e.g. a magnetic stripe reader) and a change dispenser.

In a manner known in the art, a magnetic stripe card reader may read data on the magnetic stripe of a credit or debit card, and may cooperate with conventional point-of-sale credit card processing equipment to validate card-based purchases through a conventional transaction authorization network. Suitable card-based transaction processing systems and methods are available from USA Technologies, Inc., of Malvern, Pa.

The coin acceptor, bill validator and change dispenser may communicate with a currency storage apparatus (a “hopper”) and may comprise conventional devices such as models AE-2400, MC5000, TRC200 by Mars, Inc. of West Chester, Pa., or CoinCo model 9300-L.

The coin acceptor and bill validator may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein. The change dispenser is operable to return coinage to the customer where appropriate (e.g. where, pursuant to a resolution, a refund is selected and/or where a substitute product offer is rejected by a customer).

In another embodiment, a vending machine may be configured to receive commands (e.g., payment authorization and product selection commands) through a wireless medium (e.g., a wireless device communication network), directly or indirectly, from a customer device (e.g. a cellular telephone). In such an embodiment, a payment processing mechanism may comprise a cellular transceiver operatively connected to a processor, as described herein. Systems and methods allowing for the selection of and payment for vending machine articles through cellular telephones are readily available, such as those provided by USA Technologies, Inc. Further, in such an embodiment, a customer cellular telephone may serve as an input/output device, as described herein.

Further details concerning vending machine payment processing mechanisms are well known.

The vending machine 100 may further comprise an output device 155 and an input device 160. It should be understood that, although only a single output device 155 and a single input device 160 is illustrated in FIG. 1, any number of output devices and/or input devices may be used.

In accordance with embodiments of the present invention, a vending machine may include one or more input devices for receiving input from a customer, operator, or other person. Also, a vending machine may include one or more output devices for outputting product and/or other information to a customer or operator.

Many combinations of input and output devices may be employed in accordance with embodiments of the present invention. For example, a single mechanism (e.g., a touch screen) may serve as both an input device and an output device.

As described, a vending machine may include more than one input device. For example, a vending machine may include an exterior input device for receiving customer input and an interior input device for receiving operator input. In some embodiments, however, the input device provides the dual functionality of receiving input data from both operators and customers.

As also described, a vending machine may comprise more than one output device. For example, a vending machine may include both a Liquid Crystal Display (LCD) screen and several Light Emitting Diodes (LEDs).

Output device 155 may comprise, for example, an LCD and/or one or more LEDs displays (e.g., several alphanumeric LEDs on the shelves of a vending machine, each LED being associated with a row of product inventory).

In one embodiment, an LED display screen may be mounted atop a vending machine (e.g., attached thereto, such as via bolts or other mounting hardware). Such a mounted LED display screen and may be used to communicate messages (described herein) to customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g., red, yellow, green) regarding current and upcoming promotions, as well as resolution-related data, as described herein.

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. Further, a printer may be capable of thermal line printing of various alphanumeric and graphical symbols in various font sizes (e.g. raging from 9 to 24 point) on various types of paper. Additionally, such a printer may communicate with a processor (described herein) via an RS232/IEEE 12834 and/or bi-directional parallel connection. Such a printer may further comprise a 4 KB data buffer.

Additionally, in some embodiments, an output device comprises an audio module, such as an audio speaker, that outputs information to customers audibly. Speakers may comprise conventional speakers or modern hypersonic speakers. Software may be employed in a known manner to direct the speaker to output a wide variety of sounds upon command.

Input device 160 may comprise one or more of (1) a set of alpha-numeric keys for providing input to the vending machine, such as the Programmable Master Menu® Keypad, (2) a selector dial, (3) a set of buttons associated with a respective set of item dispensers, (4) a motion sensor, (5) a barcode reader, (6) a Dual-Tone Multi-Frequency (DTMF) receiver/decoder, (7) a wireless device (e.g. a cellular telephone or wireless Personal Digital Assistant), (8) cameras, such as digital video and/or digital still photographic cameras, (9) a voice recognition module, (10) a fingerprint reader, (11) a topical facial pattern scanner/reader, (12) an iris or retinal scanner, (13) a microphone, (14) an infrared receiver, and/or (15) any other device capable of receiving a command from a user and transmitting the command to a processor.

As described, in some embodiments, a touch-sensitive screen may be employed to perform both input and output functions. Suitable, commercially-available touch screens are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with embodiments of the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known.

Vending machine 100 may further comprise one or more Inventory storage and dispensing mechanism(s) 170. Product inventory storage and product dispensing functions of a vending machine configured in accordance with a snack machine embodiment of the present invention may include one or more of: (i) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit.

In some embodiments, a vending machine may be housed in a casing of the model 129 SnackShop manufactured by Automatic Products™. In such embodiments, three removable shelves may be employed, together providing for 30 product rows and an inventory capacity of between 185 to 522 commonly vended snack products.

Inventory storage and dispensing mechanism(s) 170 may comprise one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known in the art, and need not be described in further detail herein.

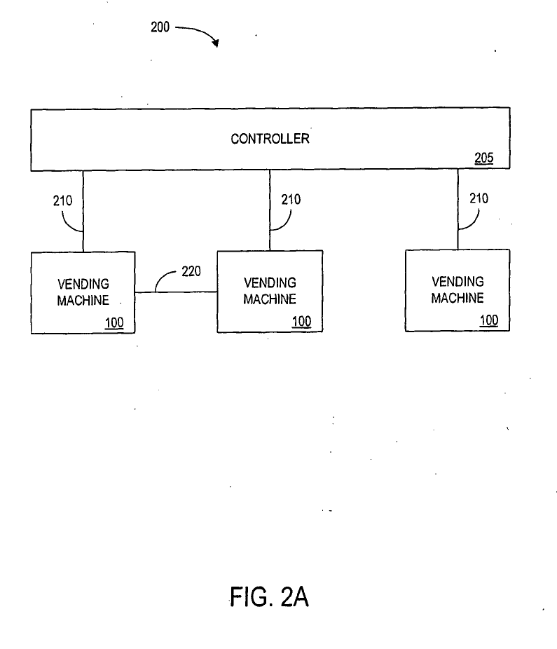

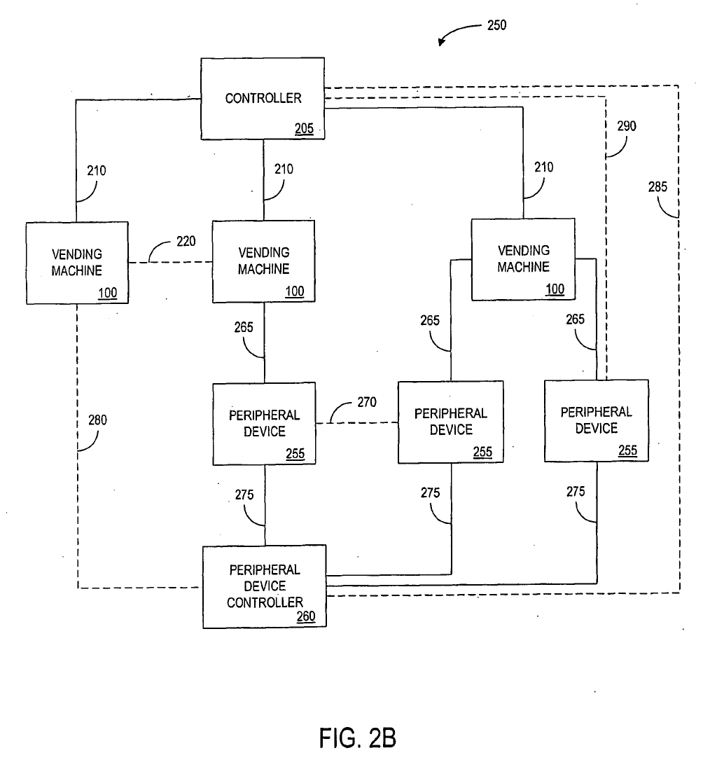

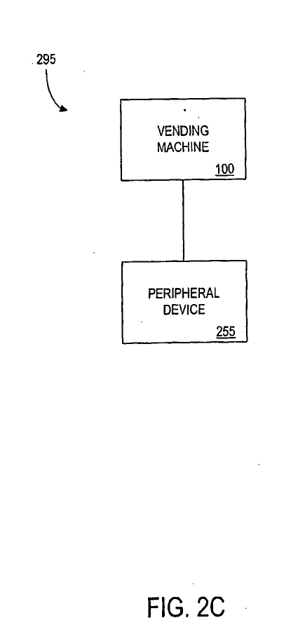

Referring now to FIG. 2A, a block diagram of a system 200 according to an embodiment includes a controller 205 that is in communication, via a communications network 210, with one or more vending machines 100. The controller 205 may communicate with the vending machines 100 directly or indirectly, via a wired or wireless medium such as the Internet, LAN, WAN or Ethernet, Token Ring, or via any appropriate communications means or combination of communications means.

Each of the vending machines 100 may comprise computers, such as those based on the Intel® Pentium® or Centrino™ processor, that are adapted to communicate with the controller 205. Further, in some embodiments, a controller 205 may comprise one or more computers, such as those based on the Intel® Pentium® processor, that may or may not be located remotely to one another or remotely to one or more of the vending machines 100. Thus, in some embodiments, a controller 205 may facilitate the transmission of data between one or more vending machines 100 and one or more operator computers (not shown) so that human operators (e.g. CSRs) may remotely interact with vending machines and/or vending machine customers. Further still, in some embodiments, system 200 includes a user device (not shown) that enables customers to transmit data to and/or receive data from a vending machine 100 and/or controller 205.

Any number and type of vending machines 100 may be in communication with the controller 205. Communication between the vending machines 100 and the controller 205, and among the vending machines 100 (which communicate via communication network 220), may be direct or indirect, such as over the Internet through a Web site maintained by controller 205 on a remote server or over an online data network including commercial on-line service providers, bulletin board systems and the like. In yet other embodiments, the vending machines 100 may communicate with one another and/or controller 205 over RF, cable TV, satellite links and the like.

Some, but not all, possible communication networks that may comprise network 210 and/or network 220 or be otherwise part of system 200 include: a local area network (LAN), a wide area network (WAN), the Internet, a telephone line, a cable line, a radio channel, an optical communications line, a satellite communications link. Possible communications protocols that may be part of system 200 include: Ethernet (or IEEE 802.3), SAP, ATP, Bluetooth™, and TCP/IP. Communication may be encrypted to ensure privacy and prevent fraud in any of a variety of ways well known in the art.

In an embodiment, the controller 205 may not be necessary and/or preferred. For example, embodiments may be practiced on a stand-alone vending machine 100 and/or a vending machine 100 in communication only with one or more other vending machines 100. In such embodiments, functions described as performed by the controller 205 or data described as stored on the controller 205 may instead be performed by or stored on one or more vending machines 100.

In the embodiment of FIG. 2 various functionality described with reference to FIG. 1 as being performed by vending machine 100 may instead or in addition be performed by controller 205. Similarly, data described with reference to FIG. 1 as being stored in a memory of vending machine 100 may, in the embodiments of FIG. 2, be instead or in addition stored in a memory of controller 205.

Referring now to FIG. 2B, a block diagram of another system 250 according to an embodiment includes a controller 205 that is in communication, via a communications network 210, with one or more vending machines 100. A difference between system 200 (FIG. 2A) and system 250 (FIG. 2B) is that in system 250 at least one vending machine 100 is also in communication with one or more peripheral devices 255 (defined above). The peripheral device 255 may, in turn, be in communication with a peripheral device controller 260 (via communication network 275). In some embodiments, the peripheral device 255 may also or instead be in communication with controller 205 (via communication network 290), one or more vending machines 100 (via communication network 265), and/or one or more user devices. In one or more embodiments the peripheral device controller 260 may be in communication with one or more vending machines 100 (via communication network 280), the controller 205 (via communication network 285), and/or a user device.

Any of the controller 205, the vending machines 100, the peripheral devices 255 and/or the peripheral device server 260 may communicate with one another directly or indirectly, via a wired or wireless medium such as the Internet, LAN, WAN or Ethernet, Token Ring, or via any appropriate communications means or combination of communications means. For example, the controller 205 may communicate directly with one of the vending machines 100 (e.g., via a LAN) and indirectly (e.g., via a vending machines 100) with the peripheral device 255. In another example, the controller 205 may communicate with one of the vending machines 100 via a LAN and with another of the vending machines 100 via the Internet.

Any and all of the controller 205, the vending machines 100, the peripheral devices 255 and the peripheral device controller 260 may comprise computers, such as those based on the Intel® Pentium® or Centrino™ processor. Further, in one or more embodiments, each of the peripheral devices 255 may comprise an external or internal module associated with one or more of the vending machines 100 that is capable of communicating with one or more of the vending machines 100 and of directing the one or more vending machines 100 to perform one or more functions.

Any number of vending machines 100 may be in communication with the controller 205. Any number and type of peripheral devices 255 may be in communication with a vending machine 100, peripheral device controller 260 and controller 205.

Communication between any of the controller 205, the vending machines 100, the peripheral devices 255 and the peripheral device controller 260, among the vending machines 100 and among the peripheral devices 255 may be direct or indirect, such as over the Internet through a Web site maintained by controller 205 on a remote server or over an on-line data network including commercial on-line service providers, bulletin board systems and the like. In yet other embodiments, any and all of controller 205, the vending machines 100, the peripheral devices 255 and the peripheral device controller 260 may communicate with one another over RF, cable TV, satellite links and the like.

Some, but not all, possible communication networks that may comprise any or all of the network 210, 220, 265, 270, 275, 280, 285 and 290, or that otherwise may be part of system 250 include: a local area network (LAN), a wide area network (WAN), the Internet, a telephone line, a cable line, a radio channel, an optical communications line, a satellite communications link. Possible communications protocols that may be part of system 250 include: Ethernet (or IEEE 802.3), SAP, ATP, Bluetooth™, and TCP/IP. Communication may be encrypted to ensure privacy and prevent fraud in any of a variety of well known ways.

In an embodiment, the controller 205 may not be necessary and/or may not be preferred. For example, various embodiments may include a stand-alone vending machine 100, one or more vending machines 100 in communication with one or more peripheral devices 255 (as illustrated in FIG. 2C), one or more vending machines 100 in communication with peripheral device controller 260, one or more peripheral devices 255 in communication with peripheral device controller 260, and/or a vending machine 100 in communication only with one or more other vending machines 100. In such embodiments, any functions described as performed by a particular device (e.g., by a vending machine 100) or data described as stored in a memory of a particular device (e.g., in a memory of a vending machine 100) may instead or in addition be performed by or stored in another device, such as another of the devices described herein (e.g., a peripheral device 255).

Similarly, peripheral device controller 260 may not be desired and/or needed in some embodiments. In embodiments that do not involve peripheral device controller 260, any or all of the functions described herein as being performed by peripheral device controller 260 may instead be performed by other devices, such as the controller 205, one or more vending machines 100, one or more peripheral devices 255, or a combination thereof. Similarly, in embodiments that do not involve peripheral device controller 260 any data described herein as being stored in a memory of peripheral device controller 260 may instead be stored in another device, such as a memory of controller 205, one or more vending machines 100, one or more peripheral devices 255, or a combination thereof.

Any or all of the vending machines 100 may, respectively, include or be in communication with a peripheral device 255. A peripheral device 255 may be a device that obtains (e.g., receives or reads) information from (and/or transmits information to) one or more vending machines 100. For example, a peripheral device 255 may be operable to obtain information about transactions being conducted at a vending machine 100, such as the initiation of a transaction, an amount of money deposited for a transaction and/or a product selected during a transaction. For example, a peripheral device 255 may monitor activities of a processor of a vending machine 100.

In one or more embodiments, one or more such peripheral devices 255 may be in communication with a peripheral device controller 260. This allows the peripheral device controller 260 to receive information regarding a plurality of transactions conducted at a plurality of vending machines 100. The peripheral device controller 260, in turn, may be in communication with the controller 205. It should be understood that any functions described herein as performed by a peripheral device 255 may also or instead be performed by another device, such as the peripheral device controller 260. Similarly, any data described herein as being stored on or accessed by a peripheral device 255 may also or instead be stored on or accessed by another device, such as the peripheral device controller 260.

An example of a peripheral device that may comprise a peripheral device 255 is the e-Port™ by USA Technologies Inc. The e-Port™ is a credit card and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., promotions and information about their transaction status.

A peripheral device 255 may be operable to receive input from customers, receive payment from customers, exchange Information with a remotely located server (e.g., controller 205 and/or peripheral device controller 260) and/or display messages to customers. A peripheral device 255 may be operable to instruct a vending machine 100 that appropriate payment has been received (e.g., via a credit card read by the separate device) and/or that a particular product should be dispensed by the vending machine. Further, a peripheral device 255 may be operable to instruct the vending machine to execute process steps and/or output messages.

The functions described herein as being performed by a peripheral device controller 260 and/or a peripheral device 255 may, in one or more embodiments, be performed by the controller 205 (in lieu of or in conjunction with being performed by a peripheral device controller 260 and/or a peripheral device 255). Such functions may be performed by the controller 205 in either system 200 (FIG. 2A) or system 250 (FIG. 2B).

In one or more embodiments, a peripheral device 255 can be useful for implementing various embodiments with no or minimal modifications to a conventional vending machine. For example, in order to avoid or minimize the necessity of modifying or replacing a program that is already stored in a memory of a conventional vending machine, an external or internal module that comprises a peripheral device 255 may be inserted in, attached to or associated with the vending machine. For example, a conventional vending machine may be retrofitted with a peripheral device 255 that is programmed or otherwise operable to implement one or more embodiments.

A peripheral device 255 may include (i) a communications port (e.g., for communicating with one or more vending machines 100, peripheral device controller 260, another peripheral device 255, and/or controller 205); (ii) a display (e.g., for displaying graphics and/or text associated with a promotion), (iii) any other output means (e.g., a speaker, light, or motion device to communicate with a customer), and/or (iv) means for providing a benefit (e.g., a printer and paper dispenser operable to dispense printed compensation codes).

In one or more embodiments, the peripheral device 255 may direct a vending machine to perform certain functions. For example, a program stored in a memory of peripheral device 255 may cause a processor of a vending machine 100 to perform certain functions. For example, a program stored in a memory of peripheral device 255 may instruct a processor and/or other components of a vending machine to dispense one or more products, dispense a monetary amount, refrain from dispensing a monetary amount, refrain from outputting a product, and/or communicate with another device.

Further, in one or more embodiments, a peripheral device 255 may cause a computer (e.g. a controller 205, a credit card processor server, a credit card issuer server, etc.) to credit a customer account (e.g. a credit card account) pursuant to a resolution (e.g. a refund).

Note that, in one or more embodiments, a vending machine 100 and a peripheral device 255 that is associated with the vending machine 100 may not communicate with one another at all. In some embodiments, however, each may communicate with a computer or other device. For example, a vending machine 100 may communicate with controller 205 and an associated peripheral device 255 may communicate with peripheral device controller 260 and/or controller 205. For example, if both vending machine 100 and peripheral device 255 are in communication with controller 205, each may obtain information associated with the other through controller 205.

It should be noted that in either the system 200 (FIG. 2A) or the system 250 (FIG. 2B), the controller 205 and/or the peripheral device controller 260 may be accessible, directly or indirectly, via another computer (communicating, e.g., over the Internet or other network) by a customer or another entity. Accordingly, a customer or other entity (e.g., an owner of the vending machine) of the other computer could communicate with the controller 205 and/or peripheral device controller 260 via a Web browser. The other computer could, e.g., receive from the controller 205 and/or peripheral device controller 260 messages described herein as being output by the vending machine or peripheral device, and/or transmit to the controller 205 and/or peripheral device controller 260 input described herein as being provided to the vending machine. Similarly, various data described herein as received through an input device of a vending machine 100 and/or peripheral device 255 may be received through a Web browser communicating with the controller 205 and/or peripheral device controller 260, which in turn communicates with the vending machine 100. Thus, an operator of the vending machine may have remote polling and reporting capabilities (e.g. remote access to vending machine databases and diagnostics), may be able to transmit instructions and/or commands to the vending machine 100, may be able to communicate with vending machine customers of vending machine 100 (via vending machine 100's Input and output devices), and the like.

Referring now to FIG. 2C, a block diagram of another system 295 according to at least one embodiment of the present invention includes a vending machine 100 that is in communication with a peripheral device 255. As described above, a prior art vending machine 100 may be retrofitted with a peripheral device 255. The peripheral device 255 may be operable to perform at least some of the methods described herein and/or to direct the vending machine 100 to perform at least some of the methods described herein, without requiring a controller 205 and/or a peripheral device controller 260. In one or more embodiments, the vending machine 100 and/or the peripheral device 255 may be accessible from a remote location via a communication port.

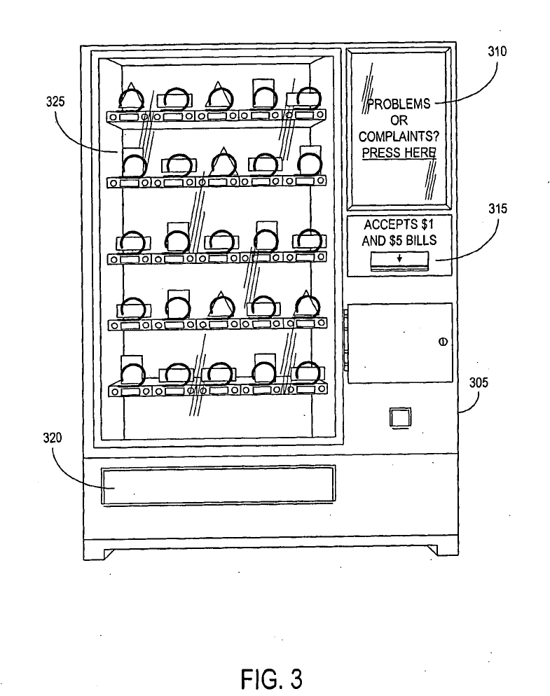

Referring now to FIG. 3, a diagram of an embodiment 300 of the external appearance of an exemplary vending machine 100 is illustrated. The embodiment 300 includes (i) a cabinet 305, (ii) an input/output device 310 for receiving information from a customer and/or outputting text and/or graphical information to a customer, (iii) a payment processing mechanism 315, (iv) an inventory dispensing mechanism 320, and (iv) a product display window 325 behind which are visible the products available for sale from the vending machine and the product storage mechanism that holds the products within the vending machine.

Cabinet 305 may be constructed from, for example, any combination of (1) commercial grade (e.g., sixteen-gauge) steel (e.g., for exterior panels and internal shelving), (2) transparent materials such as glass or Plexiglas (e.g., for product display window 325), (3) rubber (e.g., for waterproofing insulation), (4) plastic, (5) aluminum, and/or (6) any suitable material.

Many commercially available machine cabinets can be modified to work in accordance with various embodiments. For example, in snack machine embodiments, a suitable machine casing may comprise the 129 SnackShop™ manufactured by Automatic Products International, Ltd.™ of Saint Paul, Minn., which stands at 72″/1829 mm wide, has a width of 38⅞″/988 mm, and a depth of 35″/889 mm. Other suitable snack machine casings include the A La Carte™ machine from Automatic Products™, and the GPL SnackVendor™ model # 159 from Crane Merchandising Systems/Crane Co. of Stamford, Conn.

In beverage machine embodiments, machine cabinets commercially available from Dixie Narco™, Inc. of Williston, S.C. may be employed. Beverage machine cabinets may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co.™. Further details concerning the suitability of machine casing/cabinetry are well known.

It should be noted that payment processing mechanism 315 may comprise any or all of the components described with reference to payment processing mechanism 150 (FIG. 1). Similarly, product dispensing mechanism 320 may comprise any or all of the components suitable for dispensing products described above with reference to inventory storage and dispensing mechanism 170 (FIG. 1).

### Processes

Various embodiments facilitate, among other things, the resolution of vending machine customer service issues. For example, potentially dissatisfied customers of a vending machine may be permitted to register complaints, and such complaints may be addressed (e.g., by a vending machine, a computer, or a human associated therewith).

In certain “real time customer service” embodiments, a potentially dissatisfied vending machine customer may obtain a resolution to a customer service issue (e.g. a machine malfunction) at substantially the same time as the customers attempted transaction. For example, a customer may report a malfunction to a human, a vending machine, and/or a computer associated therewith, which may in turn confirm and/or record the malfunction and provide recourse to the customer (e.g. a refund), thereby alleviating the customer's potential dissatisfaction before the customer walks away from the vending machine.

In certain “asynchronous customer service” embodiments, a potentially dissatisfied vending machine customer may register a customer service issue with a vending machine or a computer associated therewith, which, after sufficient time for the issue to be identified and confirmed by a human operator and/or computer, provides a resolution of the customer service issue to the customer.

### Certain Real-Time Customer Service

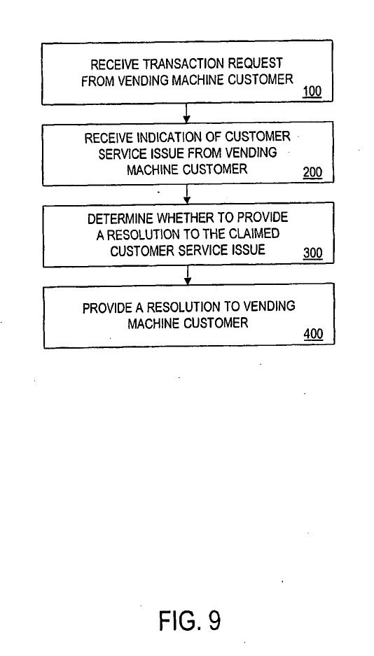

FIG. 9 illustrates an embodiment for providing substantially real-time customer service to vending machine customers. Each of the steps of this embodiment is described below.

Step 100: Receive Transaction Request from Vending Machine Customer

In an embodiment, a process begins at Step 100 as a vending machine customer attempts to transact with a vending machine by initiating a transaction with a vending machine. For example, the vending machine may receive, from the customer, a request for a product to be dispensed by the vending machine.

The customer may render payment to a payment processing mechanism 315, for example, by depositing bills and/or coins, swiping a magnetic stripe card such as a credit card or debit card, or the like. Further in some embodiments, a customer may enter, into an input device of the vending machine (such as a touch screen or thumb print reader), an account identifier that corresponds to a prepaid account or other account that authorizes a product to be dispensed by the vending machine. According to some account identifier embodiments, a customer may enter a code (e.g., a code that had been previously issued upon the establishment of a vending machine account), such as a prepaid “subscription” account that enables a customer to receive several units of product over a period of time. Typically, a subscription account (whether or not prepaid) defines a number of units of products that are redeemable, either without charge or without charge of the full retail price of the corresponding product.

Vending machine subscription accounts are described at length in Applicant's Co-pending U.S. patent application Ser. No. 10/966,407, entitled “PRODUCTS AND PROCESSES FOR MANAGING THE PRICES OF VENDING MACHINE INVENTORY”, filed Oct. 15, 2004 which claims the benefit of U.S. Provisional Patent Application No. 60/527,988, entitled APPARATUS, SYSTEM AND METHOD FOR ESTABLISHING MULTI-TRANSACTION RELATIONSHIPS WITH VENDING MACHINE CUSTOMERS, filed Dec. 9, 2003; U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999; the entirety of each is incorporated by reference herein for all purposes.

Alternatively or additionally, a customer may indicate a selection of one or more products that the customer intends to purchase from the vending machine. The customer may provide his or her selection via an input device 160 and/or via a user device in a known manner.

In some embodiments, a user device and/or controller 205 may, in whole or part, receive the transaction request from the vending machine customer. Thus, in some embodiments, a customer may transmit an account identifier to a controller 205 and/or a vending machine via a user device such as a cellular telephone or personal computer. Also, in some embodiments, a customer may transmit a selection of one or more products to controller 205 and/or a vending machine via a user device such as a cellular telephone or personal computer. For example, a customer may call a phone number posted on a vending machine with her cell phone, and a server (controller 205) running Interactive Voice Response (IVR) software may prompt her to enter an account identifier and a row position identifier corresponding to a product that she wishes to obtain from the vending machine.

Step 200: Receive Indication of Customer Service Issue from Vending Machine Customer

In an embodiment, the vending machine determines that a customer service issue exists in various manners as described herein. Specifically, in the embodiment illustrated in FIG. 9, at Step 200 the vending machine receives an indication of customer service issue from vending machine customer.

For example, the vending machine can receive, through an input device associated with the vending machine (e.g. input device 160 of FIG. 1), an indication of a customer service issue from a vending machine customer. In another embodiment, the vending machine may receive an indication of a customer service issue from a user device, or from a controller 205. In yet another embodiment, a controller 205 and/or a CSR receives an indication of a customer service issue from a vending machine customer, via a user device or a vending machine.

In some embodiments, a customer may provide such an indication after attempting to transact with a vending machine (Step 100) and realizing that the vending machine has failed to process the transaction as initially requested, or has otherwise failed to perform as expected or desired. Many such failures can result when the vending machine has malfunctioned. For example, after a customer has deposited currency into the payment processing mechanism 315, the vending machine may not have properly credited the payment that is tendered by the customer (e.g., the vending machine may have erroneously refused the payment or failed to register a credit balance equal to a deposited amount of payment).

In other embodiments, a customer may provide such an indication after attempting to transact with a vending machine (Step 100) and realizing that the vending machine has failed to dispense a requested product. For example, after a customer has deposited currency into the payment processing mechanism 315 and selected a particular product via a touch screen or other input device, the vending machine may fail to dispense the selected product because of a mechanical or electrical failure associated with the inventory storage and dispensing mechanism(s) 170.

Other types of customer service issues may relate to, e.g., a functionality of the vending machine not being performed for the customer (e.g., the vending machine was supposed to, but failed to, display a movie trailer, play a game, render a game result, play an audio file).

The customer may indicate the customer service issue in several ways, including, but not limited to, providing a response via an input device 160 to a question output via output device 155. Thus, in one embodiment, a vending machine may output a set of selectable menu options, each of which defines at least one customer service issue. The set may be presented in the form of a menu, list, grid or any other desirable format. Each selectable menu option may define a possible machine malfunction which the customer can select (e.g., via a touch screen or keypad).

For example, a vending machine may output an initial menu option reading “Problems or complaints? Press here”, such as the exemplary message on the input/output device 310 of FIG. 3. After the customer depresses the designated area of the touch screen, the vending machine may be configured to output a list of several possible malfunctions, such as “Coin jam”, “Product failed to dispense”, or “Other”. The customer may select the most appropriate menu option, thereby providing an indication of a customer service issue in accordance with this Step 200.

In one embodiment, where the customer selects an open-ended response option (e.g., “other”, as described above), the customer may be permitted to register particular details of his or her complaint via a touch screen, keypad or keyboard (e.g. The customer may type text such as “the chocolate bar I just bought was melted.”). Similarly, in another embodiment, a customer may speak a complaint into a microphone of a vending machine (an input device 160) or a user device (e.g. a microphone on a customer's cellular telephone). Such a spoken complaint would be recorded and be made retrievable (e.g., by a CSR) in a known manner.

In one embodiment in which a set of possible customer service issues is output to a customer, some or all of the menu selections may be determined (e.g., by the vending machine, the controller 205 and/or the CSR) based on an evaluation of diagnostic data. For example, in one embodiment, a vending machine processor 105 may receive data from a payment processing mechanism 150, such as sensor data, which may potentially indicate a product jam. Accordingly, the vending machine may output, as a possible customer service issue, “product jam” for possible selection by the customer. Thus, the customer may confirm the diagnostic data determined by the vending machine (e.g., received by the vending machine processor 105 from the payment processing mechanism 150).

In another embodiment, a menu of customer service issues is not presented to a customer, but rather, a customer is permitted to provide open-ended feedback about his or her experience with the vending machine. For example, a customer may speak a description of his or her customer service issue into a microphone of a vending machine (an input device 160) or an input device of a user device. Alternatively, a customer may type a description of his or her customer service issue into a keypad of a vending machine (an input device 160) or an input device of a user device.

In an embodiment, the vending machine, a controller 205 and/or a CSR receives an indication of a customer service issue via a user device that transmits an e-mail message. For example, the customer may use a PDA, personal computer, cellular phone or like device to send an e-mail (or text message, or instant message) that describes a customer service issue. Similarly, an indication of a customer service issue may be received via a user device that captures and/or transmits an image (e.g., a cellular telephone with a built-in camera), in which such a device is used to send an image (e.g., a picture of the vending machine) that describes a customer service issue. Similarly, an indication of a customer service issue may be received via a user device that transmits data from an HTML or other web-based form.

In certain embodiments, such a use of such a user device may be performed concurrently with, or very soon after, the customer transacts with the vending machine. For example, while standing in the vicinity of the vending machine, the customer may use his cellular telephone to email a customer service issue to a predetermined email address (e.g., posted on the vending machine).

In other embodiments, such a use of such a user device may be performed a substantial amount of time after the customer transacts with the vending machine. For example, a day after the transaction the customer may use his personal computer to send an email or fill in an online form via a web page.

In an embodiment, one or more customer service features (e.g. the ability of the customer to report customer service issues, the ability of the customer to communicate with CSRs, the ability of the customer to receive resolutions) are only made available to certain customers (e.g. prepaid unit account holders, customers who have registered their phone numbers or email addresses), are only made available for certain purchases (of certain products; of products priced at or above a predetermined amount), and/or are only made available at certain times of the day (e.g., times of lower sales volume).

For example, a customer purchasing one or more items that are priced a certain amount (together or separately) are permitted to speak to a CSR via a live feed; whereas customers not so purchasing items priced greater than or equal to the certain amount are not so permitted. In an embodiment, CSRs may be located in any location that permits access to a web site or to the Internet generally (e.g., from home using a personal computer).

In another embodiment, a communication session may be initiated between a customer and a CSR when a sensor detects various types of fraud at a vending machine. For example, if a motion sensor, “tilt” sensor, vibration sensor, or the like senses inappropriate motion or the like, a communication session may be established so the CSR can determine if the customer is vandalizing the machine, and if so, if there a resolution is appropriate to satisfy the customer. By way of another example, a communication session may be established when a bill validator refuses a deposited paper token. Thus, a CSR may determine if the customer appears to be presenting a real or counterfeit bill, and may instruct the bill validator to accept or refuse payment accordingly.

In an embodiment, upon detection of a customer service issue, a vending machine, controller 205, CSR and/or operator dispatches, through a communication network (e.g. PSTN; the Internet) a registered “customer service” agent who is in proximity to the vending machine. For example, owners of property on which vending machines are located, or nearby retailers, may register with the vending machine, controller 205, CSR and/or operator to receive such dispatch communications. Upon receiving such a dispatch communication, the customer service agent may approach the vending machine to confirm the customer service issue (e.g. visually confirm that a product is jammed), perform maintenance on a vending machine, and/or provide a resolution (e.g. provide a compensation code). Such customer service agents may be compensated (e.g., by the vending machine, controller 205, CSR and/or operator) in various manners, such as based on how long they are “on call”, based on how many customer service issues they respond to, and/or based on how many customer service issues they resolve.

In an embodiment, diagnostic data may comprise data indicative of user error. For example, the inputs (e.g., received via one or more input devices or via a user device) of the customer may be recorded (e.g., stored in a database) so that it can be determined whether a customer has selected a product that is out of stock, is not part of a promotion (e.g. selected an item from a first inventory group when the promotion only permits selection of items from a second inventory group), or the like. In one embodiment, if it is determined that a customer has failed to follow instructions, the customer may not be provided with a resolution because no actual customer service issue exists.

In an embodiment, if a vending machine customer is dissatisfied with a product (e.g. because it is expired or perished; because the customer dislikes the taste; because the customer didn't realize the nutritional content; because the customer accidentally selected the wrong product), the customer can deposit that product into a (special or dedicated) “return receptacle” (e.g., a locked storage bin with a slot on top). The customer may obtain a resolution, such a refund or an alternate product (e.g., once the product has been deposited). The CSR (via web cam) and/or the vending machine (via barcode reader or RFID product tag) can detect or verify that the customer has indeed returned the product before issuing a resolution.

Various information can be included with the indication of customer service issue. Such information may be automatically generated and/or appended to the received indication. For example, the received indication may include an identifier of the vending machine, the location of the vending machine, other features of the vending machine, the time and/or date of the customer service issue, the product(s) (if any) involved in a transaction that was associated with the customer service issue, a transaction identifier of the transaction that was associated with the customer service issue, transaction identifiers of transactions prior to the transaction that was associated with the customer service issue.

Step 300: Determine Whether to Provide a Resolution to the Claimed Customer Service Issue.

At Step 300, in some embodiments, a vending machine and/or controller 205 determines whether to provide a resolution to a customer service issue based on stored rules and/or diagnostic data.

In other embodiments, a CSR determines whether to provide a resolution to a customer service issue based on diagnostic data (received from a vending machine, controller 205 and/or user device, as discussed below). The CSR could, if desired, select a particular resolution and direct that the resolution be provided to the customer. For example, a CSR may receive diagnostic data and may, after contemplating whether to provide a resolution in conjunction with this Step 300, transmit a signal to the vending machine instructing the vending machine to output a resolution to the customer (e.g., Step 400, below), or transmit a particular resolution (e.g. a compensation code) to a user device, enabling the customer to receive a resolution (e.g., Step 400, below).

In conjunction with Step 300, a vending machine, controller 205, and/or a CSR may receive diagnostic data, directly or indirectly, from a vending machine's input device(s), data storage device(s), mechanical components (e.g. payment processing mechanisms 150; inventory storage and dispensing mechanisms 170) and/or from a user device. Thus, in one embodiment, a vending machine's processor 105 may receive diagnostic data (e.g. from machine components 110, 150, 155, 160, 165, 170) and determine based on the diagnostic data whether to provide a resolution in accordance with stored rules. In another embodiment, a vending machine processor 105 may receive diagnostics (e.g. from machine components 110, 150, 155, 160, 165, 170) and transmit (e.g., via communications port 165) the diagnostic data to a remote computer and/or CSR via a communications network. The remote computer and/or CSR may, in turn, determine whether to provide a resolution.

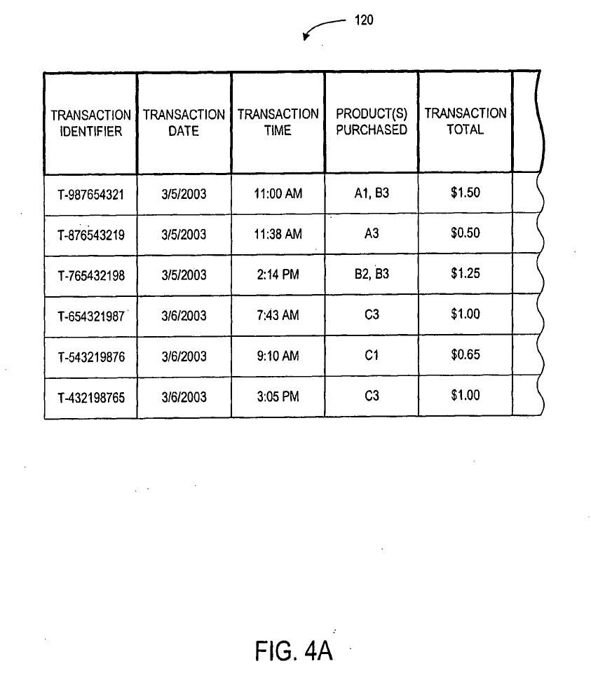

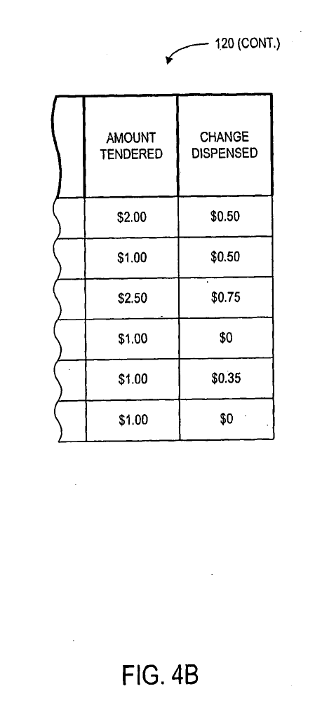

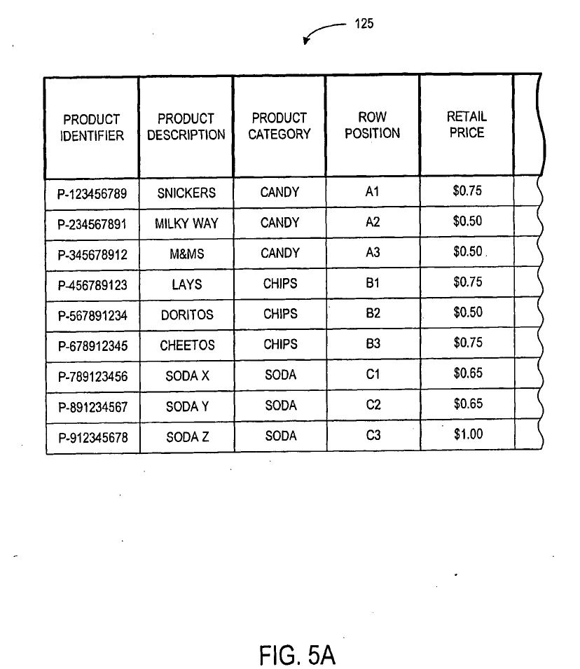

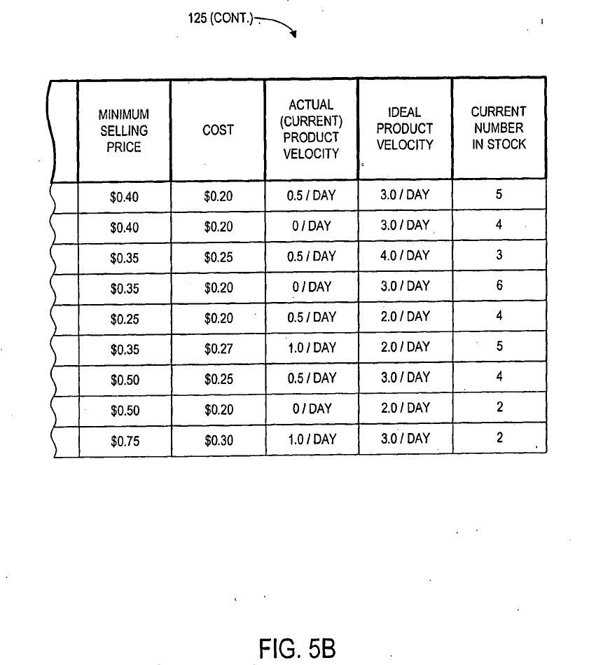

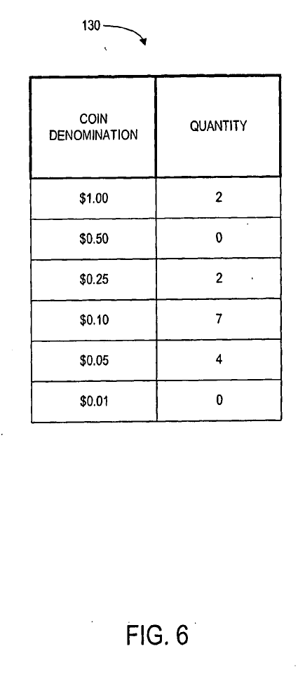

Diagnostic data may be useful in determining whether to provide a resolution to a customer service issue. Such diagnostic data may include one or more of the following:
(1) Data retrieved from a data storage device accessible to a vending machine, such as one or more vending machine databases.
   a. For example, data may be retrieved from a transaction database 120 (FIG. 1). In one embodiment, a transaction database may indicate, for each transaction or attempted transaction, one or more of: a transaction identifier, an amount deposited, an indication of the selected product(s), an indication of whether or not the selected product(s) were dispensed, whether a valid code was entered, an indication of whether or not a sensor affixed to a product delivery mechanism 320 was activated at the time of the transaction (e.g. a sensor attached to a door of a product delivery bin), and/or an indication of whether or not a sensor associated with a coin door was activated at the time of the transaction. An example transaction database 120 in accordance with one embodiment is illustrated in FIGS. 4A and 4B.
   b. For example, data may be retrieved from a product inventory database 125 (FIG. 1) so that a determination can be made as to which, if any, products may serve as an appropriate substitute product to offer a customer when an initially-requested product has failed to vend (e.g. due to a mechanical malfunction or an out-of-stock event). For example, an inventory database may indicate, for each product sold by a vending machine, a corresponding product “category” within which the product falls (e.g. both Coke® and A&W® Root Beer fall within the “Soda” category). Should a customer attempt to purchase a product (e.g. Coke®) that fails to dispense, the vending machine, controller 205, and/or CSR may access such an inventory database to determine a suitable substitute product (e.g. A&W® Root Beer) from the initially requested product's category (e.g. soda). Alternatively or additionally, a vending machine, controller 205, and/or a CSR may select, as a substitute product, a product with the same or similar retail price as the initially requested product (e.g. a vending machine offers another $0.75 product in lieu of the initially-requested $0.75 product). A product inventory database 125 according to one embodiment of the invention is provided with reference to FIGS. 5A and 5B.
   c. For example, data may be retrieved from a coin inventory database 130 (FIG. 1) so that a determination can be made as to whether a refund is an appropriate remedy, considering the amount of coins available to make change for anticipated future customers. That is, in some embodiments, a vending machine, controller 205 and/or a CSR may determine a resolution designed to conserve the working capital of a vending machine. A coin inventory database 130 according to one embodiment of the invention is provided with reference to FIG. 6.
   d. Data may be retrieved form a customer database or account database. In one embodiment, a customer who is determined to be a frequent “complainer” (e.g., submits more than a threshold number of customer service issues, submits more than a threshold number of unfounded customer service issues) can be awarded different resolutions (e.g., products rather than refunds, no resolution) than other customer would be awarded.
(2) Data provided by a customer (e.g., received via a vending machine's input device and/or a user device).
   a. Such customer-provided data may include, for example, answers to questions output by an output device 155 regarding a vending machine's operation. For example, a vending machine may output “troubleshooting” questions to a customer designed to help gather data about a vending machine's potential failure. For example, a vending machine may output, via a touch screen, a question such as “Did the product you selected get caught in the spiral? Yes or No?” The customer may, in response, depress a corresponding area on the touch screen (e.g. the underlined “Yes” or “No” text). In one embodiment, possible menu selections may comprise the complaints/customer service issues of previous customers.
   b. Alternatively, the customer may call a phone number associated with the vending machine and depress keys on a telephone, which emits corresponding DTMF tones to controller 205. The controller 205 may operate IVR software, which may instruct the controller 205 to prompt the customer with questions, as described above, which are designed to help gather data about a vending machine's potential failure. The IVR software may further be operable to diagnose, based on available data, the problem or possible problems related to the failure. Such available data may include: location of the vending machine, caller ID (phone number) of a caller who entered the customer service issue, history of issues from that phone number, and other data described herein as being material to such determinations. The customer may also provide an alphanumeric code that identifies the particular vending machine to the operator (e.g. an operator may recognize code 1238756 as indicating the vending machine located on the corner of Main Street and First Avenue).
   c. Further, a customer may call a phone number associated with the vending machine and upload digital files, such as digital picture files created and/or recorded by the customer's digital camera feature of the customer's cellular telephone. For example, a customer may take a picture of the vending machine's product display window 325 in an effort to record the vending machine's failure to dispense a product (e.g. a product may hang from a shelf, rather than drop to an inventory dispensing mechanism 320). The customer may then send the picture to a remote CSR, who may review the image and confirm that the customer is entitled to a refund.
   d. Additionally, in another embodiment, a vending machine may output, via output device 155, an “error code” which the customer may in turn provide to a controller 205 via a user device. The controller 205 and/or a CSR can use the error code to determine and/or confirm a vending machine's malfunction, and/or determine an appropriate remedy.
   e. Data received from a vending machine's cameras (e.g. internal vending machine cameras). Thus, in some embodiments, diagnostic data comprises image files (e.g. video or still images) associated with a transaction or attempted transaction. For example, in one embodiment, one or more digital cameras may, for a transaction initiated at Step 100, take pictures or videos of various vending machine components, parts and performances. Such pictures or videos may be recalled and utilized at this Step 300 to assist the vending machine, controller 205, and/or a CSR in determining whether to provide a resolution to a customer service issue. For example, a picture may reveal that a snack product has failed to vend because it became jammed in a product dispensing helix.
(3) Data received from a payment processing mechanism.
   In one embodiment, data regarding the status of a coin acceptor may be retrieved and analyzed by the controller 205 to determine if a coin acceptor is jammed (e.g. sensors in a coin delivery chute may generate signals indicative of a coin jam), if a credit balance has been established, or the like. In another embodiment, data regarding the balance of currency stored in conjunction with a payment processing mechanism (e.g. a “hopper”; coin tubes) may comprise diagnostic data. Thus, the working capital of a vending machine may be analyzed to determine, for example, if the machine has sufficient currency to provide a customer with a particular currency-based resolution to a customer service issue (i.e. a cash refund).
(4) Data received from inventory storage and dispensing mechanism(s) 170.
   For example, sensors associated with Inventory storage and dispensing mechanism(s) 170 may indicate that a particular mechanism has failed or is likely to have failed. For example, sensors may indicate that a product dispensing mechanism (e.g. a motor mounted to a double-helix configuration shelf dispenser) was actuated but that the product jammed prior to being delivered to inventory dispensing mechanism 320 (e.g. a weight sensor or infrared sensor was not triggered in the vending machine's delivery bin area). Also, sensors associated with dispensing mechanism 320 may indicate that a product delivery door was not opened, which may provide circumstantial evidence that a machine did not dispense a requested item (i.e., because a customer may not open a product delivery bin door unless the customer witnessed through the product display window 325 the product being delivered to the delivery bin).
(5) Data received from any hardware sensor (e.g. thermometers, power supply sensors, sensors operable to detect the motion of the spiral or other dispensing mechanism).

In an embodiment, a communication link is established between an input/output device 310 of the vending machine and a device operated by a CSR, such as a controller 205 or a computer associated therewith (e.g. a customer service terminal). Such communication may comprise a telephonic or Internet-based communication. Thus, in some embodiments, a “web camera” or another image capture device mounted to or near the vending machine and/or a “web camera” or another image capture device mounted to or near the CSR's computer may provide substantially real-time images of the customer (to the CSR) and/or the CSR (to the customer). Alternatively or additionally, a two-way audio-based (e.g. telephonic) communication can be enabled between the CSR and the customer (e.g. through the Public Switch Telephone Network (PSTN), through Internet-transmitted audio streams). Further, a two-way text-based communication (e.g. instant text messaging) can be enabled between the CSR and the customer.

Pursuant to the communication, the CSR may obtain information from the customer (“diagnostic” or otherwise) to help assist the CSR in making a determination of whether or not a resolution should be provided, and if so, type and degree of resolution. Thus, pursuant to the communication, the CSR may assess the genuineness of the customer's stated customer service issue and may assess the value of the customer to the vending machine operator (e.g., is the customer a loyal, repeat customer; or a one-time, transactional customer?). While communicating with the customer, the CSR may also receive and analyze other diagnostic data (e.g. machine sensor data; image files) to help in the determination of whether to provide a resolution. For example, a CSR may communicate with a customer over a two-way audio-based communication while receiving data from the vending machine that indicates whether or not a product delivery door was opened (e.g. data received from sensor that monitors inventory dispensing mechanism 320). For example, if the product delivery door was opened (e.g., as indicated by the sensor), the CSR may determine that the customer had reason to open the door, and may thus discredit the customer's verbal assertion that a product failed drop from a shelf to the dispensing bin. By way of another example, the CSR may receive account information (associated with an account identifier entered by the customer at Step 100) to assess the value of the customer to the vending machine operator; established, valuable customers may be given the benefit of the doubt as to the genuineness of a stated customer service issue.

In some embodiments, during the communication, the CSR can negotiate a resolution with the customer. For example, where a customer reports (at Step 200) that a selected item failed to dispense, the CSR may ask the customer (at Step 300) if she is amenable to accepting a different, substitute product. The CSR may offer a higher-priced or otherwise greater-value product (e.g. bigger size) in the interest of ensuring the customer's satisfaction. Or, the CSR may offer a similarly priced product from the same product category as the initially requested product (e.g. the CSR may offer another beverage, another salty snack, another candy bar). In some embodiments, during the communication, the CSR may inform and educate customers about new vending machine promotions, features, and the like.

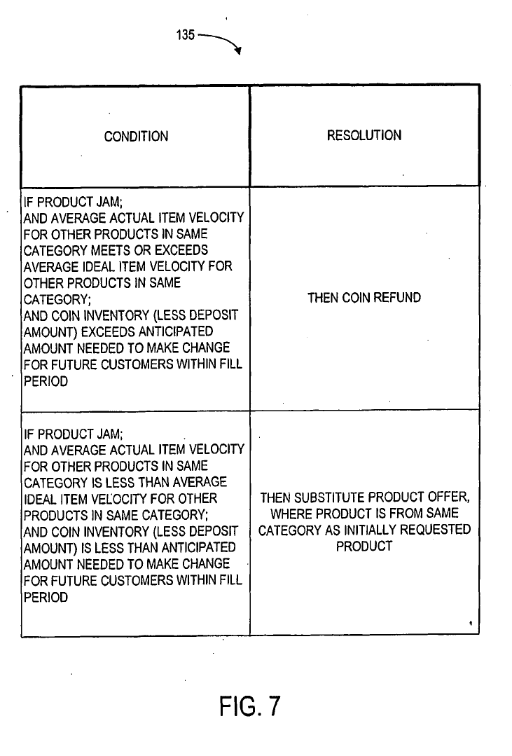

As stated, in some embodiments, a vending machine and/or controller 200 may determine whether to provide a resolution based on an evaluation of diagnostic data in light of stored rules. In accordance with one embodiment of the invention, such rules may be stored in a database, such as resolution rules database 135 (FIG. 1). A resolution rules database 135 in accordance with one embodiment of the invention is provided with reference to FIG. 7. In general, and according to an embodiment, a database may define a resolution for one or more corresponding conditions.

In the exemplary tabular database of FIG. 7, for each condition, a corresponding resolution is provided. Conditions may generally indicate the state of a vending machine, as may be determined through diagnostic data or other data. For example, the first exemplary record indicates that the resolution of a coin refund is to be provided to a customer when (1) there is a product jam (e.g. as reported by a sensor in the inventory storage and dispensing mechanism(s) 170 and/or as reported by a customer via an input device 160 or a user device); (2) the average actual item velocity for other products in the same category as the initially requested products meets or exceeds the average ideal item velocity for other products in the same category; and (3) the coin inventory (less the customer's deposited amount) exceeds the anticipated amount needed to make change for future customers within the fill period. Thus, the exemplary rule of the first record of FIG. 7 functions to refund customers potentially disappointed from a product jam when sales of other products in the same category as the initially requested product are strong during the fill period and there would likely be sufficient coin inventory, after the refund, to make change for the anticipated future customers within the fill period.

The second exemplary record of the resolution rules database provides that a substitute product offer should be provided to a customer when (1) there is a product jam (e.g. as reported by a sensor in the inventory storage and dispensing mechanism(s) 170 and/or as reported by a customer via an input device 160 or a user device); (2) the average actual item velocity for other products in the same category as the initially requested product is less than the average ideal item velocity for other products in the same category; and (3) the coin inventory (less the customer's deposited amount) is less than the anticipated amount needed to make change for future customers within the fill period. Thus, the exemplary rule of the second record of FIG. 7 functions to provide a substitute product offer to a customer potentially disappointed from a product jam when sales for other products in the same category as the initially requested product are less than ideal during the fill period and there would not likely be sufficient coin inventory, after the refund, to make change for the anticipated future customers within the fill period. As indicated by the resolution field of the second record of FIG. 7, the substitute product offer must comprise an offer to the customer to receive a different product from the same category as the initially requested product.

Together, the first and second records of the illustrative database of FIG. 7 permit a vending machine, upon the occurrence of a product jam, to provide refunds to customers when stored currency is abundant and sales are strong, and substitute product offers to customers when sales are less than ideal, and currency reserves are low (e.g., as compared to predicted currency needs). Thus, in one embodiment, a vending machine may provide the most appropriate resolution to a customer by considering future sales opportunities. In other words, a vending machine may provide a refund when the vending machine determines that no more coin inventory will be needed to make change for anticipated future customers. Alternatively, a vending machine may attempt to essentially sell a substitute product in lieu of the initially requested product when the vending machine could use the deposited currency for anticipated future customers and when sales of possible substitute products are slow.

To execute the exemplary rules of FIG. 7, the vending machine processor 105, the controller 205, and/or a CSR may have access to (1) a transaction database 120, as provided by FIGS. 4A and 4B; (2) a product inventory database 125, as provided by FIGS. 5A and 5B; and (3) a coin inventory database 130, as provided by FIG. 6.

Executing the exemplary rules of FIG. 7 in accordance with the exemplary data provided by the databases of FIGS. 4-6, it may be determined that, should Soda X jam in the inventory storage and dispensing mechanism 170 after a customer deposited $0.65 (Soda X's retail price per FIG. 5A), a substitute product offer for Sodas Y or Z is appropriate as a resolution because: (1) Sodas Y and Z are in the same product category (“soda”) as Soda X, the initially requested product; (2) the average actual item velocity for Sodas Y and Z is 0.5/day, which is less than the average ideal item velocity for Sodas Y and Z (2.5/day); and (3) the total coin inventory ($3.40) less the deposited amount ($0.65) is less than that which may be needed to make change for future customers within the fill period. Specifically, the transaction database 120 of FIGS. 4A and 4B indicates that the average change dispensed per day is ˜$0.35. Assuming, for this example, that there are 13 days remaining in the fill period, $4.55 in coin inventory may be needed to make change for customers throughout the remainder of the fill period, assuming that the historic transaction patterns in the transaction database 120 (e.g., transaction velocity, change due, etc.) are indicative of future transaction patterns. Thus, the amount of change anticipatorily needed to make change for the remainder of the fill period ($4.55) is greater than the total coin inventory less the amount deposited ($2.75).

In addition to or instead of a resolution being provided, it may be determined to take other appropriate actions upon receiving a customer service issue. For example, the nature of the customer service issue may warrant notifying a technician to investigate, repair and/or restock the vending machine.

Step 400: Provide a Resolution to Customer

At Step 400, a vending machine, a controller 205 and/or a CSR may provide to a customer, via a vending machine or a user device, a resolution. As stated, a resolution may comprise any benefit (e.g., a concession or compromise), or an indication thereof. The resolution may be offered on behalf of a vending machine operator in an effort to satisfy a vending machine customer who is actually or potentially dissatisfied due to an outstanding (i.e. unresolved) customer service issue.

In some embodiments, resolutions may permit vending machine customers to receive, in lieu of an initially requested product and/or a previously deposited amount of currency, one or more of:
(1) A substitute good and/or service (i.e. a product other than a product indicated by the request) offered by a vending machine, including tangible goods (e.g., food, beverages, compact discs), intangible goods, such as digital content (e.g., MP3 downloads, music files), and services (e.g., Internet access, telecommunications access, subscription to digital streaming media services). A customer may be permitted to select a substitute product from a set of products that are each indicated by lights (e.g. flashing LEDs), icons (on touch screens), or other indications. The set of products may be determined based on available data (e.g. sales data, in which products that are selling slower and/or products that are yielding higher profits are offered as substitute products).
(2) money dispensed from or otherwise provided by a vending machine;
(3) monetary credit established in a credit balance (e.g. of a vending machine's payment processing apparatus);
(4) credits added to or otherwise applied toward a customer account, including credit card accounts, debit card accounts, stored value accounts and “subscription” or prepaid unit accounts.
(5) Vouchers (e.g., tickets, tokens, codes, “compensation codes”, coupons, or the like) which entitle vending machine customers to receive, from a vending machine, substitute products, bonus products, monetary credits, discounts, or the like; and/or
(6) Vouchers (e.g., tickets, tokens, codes, “compensation codes”, coupons, or the like) which entitle the recipient (e.g., the vending machine customer) to receive, from a retail store (e.g. a nearby retailer), substitute products, bonus products, monetary credits, discounts, or the like. Thus, in some embodiments, the recourse that is provided to a customer may comprise an entitlement to receive a product typically sold by a retailer within the general proximity of (e.g., within walking distance of, in the same building as) a vending machine. In such embodiments, a participating retailer may have a relationship with a vending machine operator to accept compensation codes as payment for such product(s), provided the vending machine operator subsequently reimburses the retailer for the cost or price of the product(s). Thus, in some embodiments, third party retailers may help resolve customer service issues.
(7) Reservations of one or more products for a customer. In other words, a product (or a predetermined number of units thereof) may be deemed not dispensable to anyone except a customer who is entitled to receive the reserved product. In one embodiment, a customer may be provided with a compensation code which, when redeemed, entitles the customer to the requested product.

Resolutions may be communicated and/or provided to customers in many ways. In some embodiments, resolutions may be output to customers through an output device 155 of a vending machine. For example, a vending machine may output, on a touch screen, a resolution to a potentially dissatisfied customer enabling the customer to select either a refund or a substitute product (e.g. “We're sorry your product got stuck! Press here for your money back; or press here to try new Lime Flavored Diet Coke® instead.). Depending on the customer's selection, the appropriate mechanism (payment processing mechanism 150; inventory storage and dispensing mechanism 170) may be activated (e.g., so that a customer may receive a cash refund or a substitute product).

In some embodiments, resolutions may be output to customers through a printer of a vending machine. For example, a vending machine may be configured to print and output a ticket with a compensation code thereon, which enables a potentially dissatisfied customer to receive a refund from one or more vending machines (not necessarily the same vending machine at which the customer service issue existed). Thus, in one embodiment, a customer who is entitled to a refund may receive a compensation code from a first vending machine and present the compensation code to the input device of a second vending machine, which may provide the refund. Alternatively, compensation codes may be provided to retailers who may provide such refunds.

In an embodiment, if it is detected that there is a problem with the printer (e.g., out of paper, out of toner or ink) or the dispenser (e.g., fails to feed tickets correctly), then the matter which should have been printed (e.g., prices, coupons, codes, receipts) can be send via alternative communication means (e.g., email, text message, phone call with text-to-speech generation of a spoken message).

In another embodiment, a vending machine may print, as a resolution, a voucher that entitles the customer to receive the initially requested product or a substitute product from a second vending machine or a local retailer. Thus, in one embodiment, a customer who is entitled, pursuant to a resolution, to a product from a second vending machine or from a retailer may receive a compensation code from a first vending machine and present the code to the input device of a second vending machine or to a retail sales clerk, which may in turn provide the product.

In such an embodiment, where a resolution is provided by either a retailer or by a vending machine other than the vending machine at which the customer service issue existed, there can be recordation and reconciliation of such resolution. For example, each resolution can be associated with the vending machine at which the corresponding customer service issue existed (e.g., each coupon code can be associated, in a database, with a first vending machine). Each resolution can also be associated with the retailer or vending machine which provides the customer with the benefit (e.g., each coupon code can be associated, in a database, with a second vending machine or with a retailer). Thus, in an embodiment where the payment received by each vending machine must match the products or other benefits dispensed by the vending machine, the tracking of customer service issues and corresponding resolutions among various vending machine/retailers can facilitate reconciliation, such as billing or transfers of payment among vending machines, among vending machine operators, and/or among retailers and vending machine operators.

In embodiments where vending machine customers receive compensation codes, printed vouchers, tickets or the like which entitle them to refunds, products or discounts from other machines or retailers, the other machines or retailers may validate such entitlements by consulting a local or remote database. For example, when a vending machine customer who receives a compensation code from a first vending machine presents the code to a second vending machine, the second vending machine may search a local database or a remote database (e.g. a database of the first vending machine) to determine if the code is a validly issued code. If so, the second vending machine may provide the appropriate resolution (e.g. a refund, a product, a discount) and may record the provision of the resolution in a database so that accounts may be subsequently reconciled (e.g. an operator of the second machine may seek reimbursement from the operator of the first machine based on how many resolutions were fulfilled/redeemed through the second vending machine). Likewise, when a vending machine customer who receives a compensation code from a first vending machine presents the code to a retailer, the retailer may consult a local or remote database (e.g. through a point of sale terminal) to confirm the validity of the code. Upon confirmation, the retailer may provide the resolution (e.g. a refund, a product, a discount) and record provision of the resolution.

In an embodiment, a compensation code may include an email, text message or other communication sent to a user device (e.g., a cellular telephone). Replying to such a communication (e.g., replying to an email) could constitute inputting of the compensation code. Thus, I such an embodiment the user need not actually know the compensation code to redeem the code.

In some embodiments, resolutions may be output to customers through a payment processing mechanism 150 of a vending machine. For example, a vending machine may dispense coinage as a resolution (e.g. a refund amount which may, but need not, equal the amount of payment that the customer rendered).

In some embodiments, resolutions may be output to customers through an inventory storage and dispensing mechanism 170 of a vending machine. Thus, in some embodiments, a vending machine may automatically dispense a substitute product to a potentially dissatisfied customer. For example, where a customer selects a 12 oz. can of Coke® which fails to dispense due to a malfunction of the inventory storage and dispensing mechanism 170, the vending machine may automatically dispense a 20 oz. bottle of Coke® as a resolution.

In some embodiments, resolutions may be output to the customer through a user device. For example, a customer may receive, via cell phone, a compensation code from a controller 205 or a CSR. In some embodiments, a compensation code may be alphanumeric, so that a customer may hear (e.g., from a speaker of a cellular phone) or see (e.g., on an LCD screen of a cellular phone) the code and, in turn, enter the code into an input device 160 of the vending machine (e.g. a keypad) so that product or currency may be dispensed. In other embodiments, a compensation code that is transmitted to a user device from a controller 205 may comprise computer readable indicia, such as, but not limited to (1) bar coded Information, such as a two dimensional bar code, which may be output through an output device of a user device (e.g. an LCD screen of a cellular phone) and in turn read by an input device 160 of a vending machine; and (2) a DTMF tone sequence which may be output through an output device of a user device (e.g. a speaker of a cellular phone) and in turn read by an input device 160 of a vending machine.

Compensation codes may permit customers to receive any resolution described herein. Further, compensation codes may function to instruct vending machines to cease advertising and/or selling products corresponding to a reported malfunction. For example, if products positioned in a particular row of a particular shelf are not dispensing because of a product jam on a helix, the compensation code may instruct the machine to disable the sale of products from that row, may turn off lights associated with that row, may cease outputting advertisement content associated with the corresponding products, or the like.

In some embodiments in which a CSR determines a resolution, the CSR may transmit, via network connection, a command to a vending machine to provide a resolution. For example, a CSR may remotely instruct a vending machine to dispense currency (from payment processing mechanism 150), a product (from inventory storage and dispensing mechanism 170), and/or a compensation code (from output device 155). The CSR may also instruct the vending machine to cease advertising and/or selling products corresponding to a reported malfunction. For example, if products positioned in a particular row of a particular shelf are not dispensing because of a product jam on a helix, the CSR may instruct the machine to (i) disable the sale of products from that row, (ii) turn off lights associated with that row, and/or (iii) cease outputting advertisement content associated with the corresponding products, or the like.

In an embodiment where it is determined that a product has failed to be dispensed and/or a product has been provided as a resolution, a vending machine, controller 205, CSR and/or operator may use such information to update a data record (e.g. a “plan-o-gram”, as is known) or other record that is used as a guide for stocking a vending machine with particular products. Thus, where a vending machine has failed to vend product X because of a mechanical malfunction, and a corresponding resolution is to provided a customer comprising two units of product Y, a data record may instruct an operator (e.g. a route driver) to stock at least two units of product Y in the next fill period to account for the units of Y dispensed or to be dispensed pursuant to the resolution.

In situations where it is determined that the malfunction indicates a chronic problem (e.g., a certain product row rarely operates as intended), that feature can be disabled (e.g., products in that product row are unable to be selected by a customer).

In an embodiment, upon a determination (e.g., by a vending machine, controller 205, CSR and/or operator) that a particular product row is malfunctioning (e.g. due to a product jam on a helical dispensing rod), a portion of the product display window may be tinted or otherwise altered so that the corresponding product cannot be seen by customers. Thus, jammed products are not advertised for sale.

### Certain Asynchronous Customer Service Embodiments

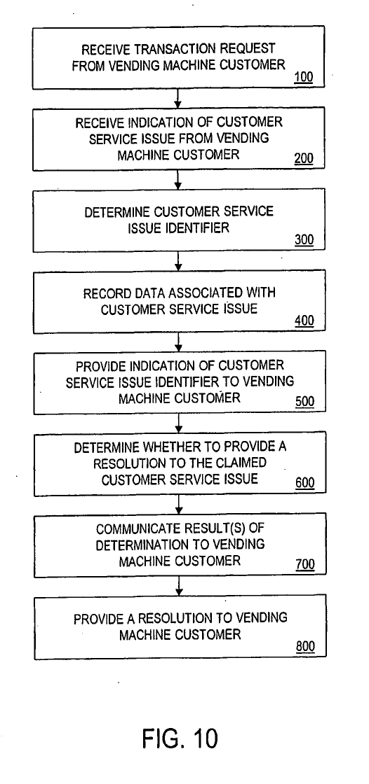

FIG. 10 describes an embodiment for providing asynchronous customer service to vending machine customers. The steps of FIG. 10 are described in more detail below. Various steps, and embodiments of those steps, have been described above.

Step 100: Receive Transaction Request from Vending Machine Customer

As described herein, a vending machine customer attempts to transact with a vending machine by initiating a transaction with a vending machine.

Step 200: Receive Indication of Customer Service Issue

As described herein, a vending machine receives an indication of a customer service issue (e.g., from a vending machine customer).

Step 300: Determine Customer Service Issue Identifier

In an embodiment, a customer service issue identifier may be determined so that the customers stated customer service issue can be tracked and subsequently referred to by the vending machine, controller 205, operator and/or customer. Thus, after a customer service issue identifier is determined (Step 300), it may be recorded at Step 400 (below) in conjunction with other customer service issue data (e.g. diagnostic data, data received from a customer at Step 100, etc.) and provided to a customer at Step 500 (below). After a period of time sufficient for an operator, vending machine and/or controller 205 to evaluate the customer service issue (at Step 600, below), the customer may then use the customer service issue identifier to inquire as to the status of the outstanding customer service issue at Step 700, below (i.e. to see whether or not a resolution is to be provided).

Further, in an embodiment, a customer service issue identifier may be determined so that a message may be transmitted to a customer (at Step 700, below) after a period of time sufficient for an operator, vending machine and/or controller 205 to evaluate the outstanding customer service issue (Step 600, below). The message may indicate a status of the outstanding customer service issue (e.g. a message indicating whether or not an operator has determined to provide a resolution to the reported customer service issue).

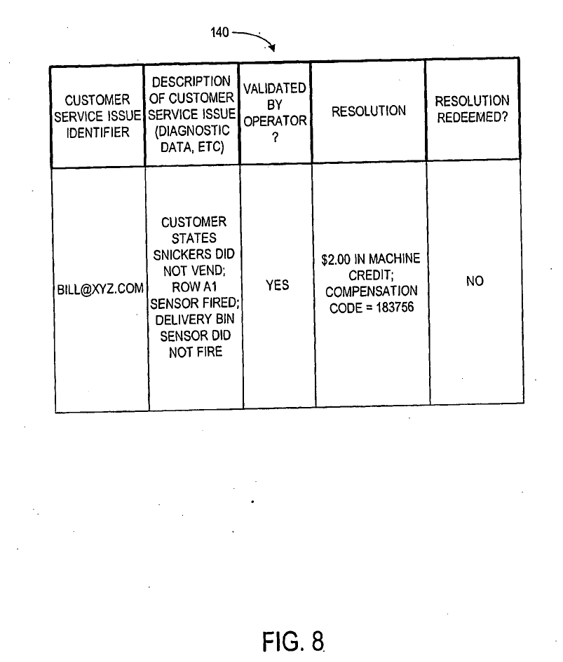

At Step 300, a vending machine and/or controller 205 determines a (unique) customer service issue identifier. In one or more embodiments, a customer service issue Identifier comprises one or more of:
(1) A substantially unique alphanumeric code generated by the vending machine processor 105 or a controller 205. For example, in one embodiment, a vending machine processor 105 may be configured to generate non-sequential numbers which may be recorded and/or provided to potentially dissatisfied customers as customer service issue identifiers.
(2) A substantially unique alphanumeric code retrieved from a database. Thus, in one embodiment, a vending machine may store, in a database, customer service issue identifiers for selection/retrieval by a processor 105 at Step 300. Such identifiers may be a randomly generated set of codes. Such identifiers may be grouped, such that certain codes are to be used with certain types of customer service issues.
(3) A substantially unique identifier provided by the customer. Thus, in one embodiment, a customer may provide an identifier to a vending machine and/or controller 205 via an input device 160 (e.g. a keypad) and/or a user device (e.g. a cellular telephone).
   a. In one or more embodiments, a customer may provide information which identifies the customer, such as his or her contact information (e.g., the customers name, address, phone number, email address, and the like). Thus, in some embodiments, potentially dissatisfied customers may enter their email addresses or phone numbers and receive (e.g., at Step 700, below) emails or phone calls with resolution notifications (including compensation codes redeemable for products or refunds) once issues have been confirmed by the operator, vending machine, and/or controller 205 at Step 600, below.
   b. In one or more embodiments, information which identifies the customer includes the customer's social security number.
   c. In one or more embodiments, a customer may request/select, as a substantially unique identifier, a personal identification number (PIN) using a keypad of a vending machine (an input device 160) and/or a user device (e.g. a keypad of a cellular telephone). In some embodiments where a customer requests/selects a PIN, the vending machine and/or controller 205 may be configured to access a customer service issue database 140 (FIG. 8) to determine if a requested/selected PIN has been previously registered in accordance with a previous customer service issue. If so, the vending machine may output a message to the customer (via output device 155 or an output device of a user device, such as an LCD of a cellular telephone), informing the customer that the requested/selected PIN is unavailable. The customer may alternatively or additionally be prompted to request/select another PIN, and the process may repeat until the customer has selected a substantially unique (e.g. not previously issued and/or outstanding) PIN.
   d. In one or more embodiments, a customer may provide, to an input device 160 and/or a user device, a biometric identifier, including but not limited to a finger print, iris pattern, topical facial pattern, voice print, signature, or the like. Suitable devices for receiving biometric data and generating biometric identifiers include, image capture devices (e.g., digital cameras), audio input devices (e.g., microphones), fingerprint readers, and retinal eyeprint readers.
   e. In one or more embodiments, a customer's user device may provide an identifier to a vending machine and/or controller 205 which may serve as a customer service issue identifier. For example, in one embodiment, a customer's cellular telephone number may be transmitted to the vending machine and/or controller 205, directly or indirectly, via automatic number identification (ANI) technology. In another embodiment, a user device's serial number or other identifier may be transmitted to the vending machine and/or controller 205. In another embodiment, the unique signature of the customer's cellular telephone may be read by a suitable cellular receiver (e.g., a peripheral of the vending machine) and such signature used to identify the customer.

Step 400: Record Data Associated with Customer Service Issue

At Step 400, a vending machine and/or controller 205 records data associated with a customer service issue. In one or more embodiments, a vending machine and/or controller 205 records any data received at Step 200 and/or determined at Step 300 in a customer service issue database 140 (FIG. 8). As illustrated by FIG. 8, in one embodiment, a customer service issue database may store, for each customer service issue identifier, a description of a corresponding customer service issue (e.g. including diagnostic data, customer description of the customer service issue, and/or other data), an indication of whether or not the issue has been validated or confirmed by the operator (e.g., at Step 600, below), and indication of a corresponding resolution (if any), and an indication of whether or not any resolution has been redeemed by a customer (e.g., at Step 800, below). Such recorded data may be associated with, e.g., information which identifies the customer and/or contact information of the customer.

Step 500: Provide Indication of Customer Service Issue Identifier to Vending Machine Customer

In one or more embodiments, an indication of the determined customer service issue identifier is provided to the customer.

In some embodiments, a customer service issue identifier (e.g., which is generated by the vending machine or another device, rather than input by the customer) is output to a customer through an output device 155 of a vending machine (e.g., a display, a printer) or an output device of a user device (e.g. an LCD screen of a cellular phone; a speaker of a cellular phone). In one embodiment, a potentially dissatisfied customer may receive a printed “service ticket”, comprising one or more of a printed (i) customer service issue identifier, (ii) a time for the customer to return to the vending machine (e.g. to see if the they are entitled to a resolution), and/or (iii) a phone number or web site address that the customer may call or visit to check on the status of an outstanding customer service issue by providing a customer service issue identifier through a user device such as a phone or personal computer. In another embodiment, a potentially dissatisfied customer may receive, via email, a virtual “service ticket”.

In embodiments where customers request/select a customer service issue identifier (e.g. where a customer selects/requests a PIN), the vending machine, controller 205 and/or user device may alternatively or additionally output a confirmation or rejection of the requested/selected customer service issue identifier depending on whether or not the requested/selected customer service issue identifier previously exists in a customer service issue database 140 (e.g. a message may be output indicating “Your selected PIN is now registered; please check back tomorrow by entering your PIN into the keypad”).

In some embodiments, a customer service issue identifier may be in machine-readable form and may be downloaded to a user device, such as a cellular phone or a personal computer. For example, a “cookie” file indicative of the customer service issue may be downloaded to a customer's personal computer.

Step 600: Determine Whether to Provide a Resolution to the Claimed Customer Service Issue

As described above, it is determined whether or not a resolution to the claimed customer service issue should be provided.

For example, in one embodiment, a route driver may approach a vending machine at the end of a fill period to perform various tasks, including inventory restocking and currency withdrawals and/or deposits. Further, a route driver may (remotely or locally) access a customer service issue database 140 to retrieve reported outstanding customer service issues. The route driver may also access diagnostic data associated with an outstanding customer service issue so that the operator may determine the validity of a reported customer service issue and so that the operator may repair any continuing machine malfunctions.

In another embodiment, a vending machine and/or controller may be configured to automatically determine whether to provide a resolution periodically. For example, in one embodiment, a vending machine may be programmed to determine whether to provide a resolution every night at 12:00 PM. In another embodiment, a vending machine may be programmed to determine whether to provide a resolution when sales are slow, such as when average actual product velocity is less than a certain threshold. In another embodiment, a vending machine may be programmed to determine whether to provide a resolution when an input device such as a motion detector does not detect the presence of a customer for at least a predetermined period of time. Thus, a vending machine may be configured to determine whether to provide a resolution at a time not likely to conflict with the processing of sales transactions.

In one embodiment, whether a resolution is appropriate may be determined, as described herein, by consulting a resolution rules database 135, a coin inventory database 130, a product inventory database 125, and/or a transaction database 120.

Upon the determination of whether to provide a resolution, the determination and/or the reasons leading to the determination may be recorded (e.g., in a customer service issue database 140 of FIG. 8). Thus, upon determining the validity of one or more outstanding customer service issues, the route driver may update the customer service issue database 140 by indicating, for each outstanding issue, whether or not the issue was valid and, if so, an appropriate resolution. For example, a route operator may confirm that a product (e.g. Soda X) in fact jammed in an inventory storage and dispensing mechanism 170, and may record that a refund is appropriate in an amount equal to the retail price of the product (e.g. $0.65).

Step 700: Communicate Result(s) of Determination to Vending Machine Customer

At Step 700, the result(s) of the determination made in Step 600 are communicated to the customer. Thus, in some embodiments, the customer is informed whether or not she is entitled to a resolution to her customer service issue.

In some embodiments, a vending machine, controller 205 and/or operator communicates the result(s) through an output device 155 of a vending machine. In other embodiments, the result(s) are communicated through an output device of a user device (e.g. an LCD display of a cellular telephone).

Further, in some embodiments, results are “proactively” communicated by being automatically communicated through an output device 155 of a vending machine or an output device of a user device. For example, a vending machine may post, on an LCD display, a list of recently validated customer service issues and their corresponding resolution(s) (if any). In such an embodiment, customers may view the LCD display and search for their customer service issue based on their customer service issue identifier (registered/issued at Step 500), and, at Step 800 (below), such customers may redeem or claim any resolutions due.

In yet another “proactive” example, a vending machine and/or controller 205 may be configured to output communications to customers upon resolution of customer service issues. For example, where a customer has provided an email address at Step 300, the vending machine and/or controller 205 may transmit an email message to the customer indicating the result(s) of the determination made at Step 600. Alternatively or additionally, where the customer has provided a telephone number at Step 300, the vending machine and/or controller 205 may transmit a telephonic communication (text-based or audio-based) to the customer's telephone indicating the result(s) of the determination made at Step 600. Email or telephonic communications may, in some embodiments, include compensation codes.

In other embodiments, results are “reactively” communicated by being provided to customers only upon customer inquiry or request. For example, in one embodiment, a vending machine may provide customers, via touch screen, with a menu option enabling customers to check the status of any outstanding customer service issues. A customer may select the menu option, and may be in turn prompted for her customer service issue identifier. The vending machine and/or controller 205 may search the customer service issue database to determine if the provided customer service issue identifier corresponds to a resolved customer service issue, and if so, may output an indication of the corresponding resolution. In another “reactive” embodiment, a vending machine and/or controller 205 may host a web site that enables customers to enter customer service issue identifiers and learn the results of the determination made at Step 600. Further, in yet another “reactive” embodiment, a vending machine and/or controller 205 may run IVR software which permits customers to (i) call a phone number, (ii) provide customer service issue identifiers, and (iii) learn the results of the determination made at Step 600.

Step 800: Provide a Resolution to Vending Machine Customer

As described herein, a resolution may be provided to a customer in any of a number of manners.

In some embodiments, resolutions are provided to customers through one or more vending machines. Thus, in embodiments where a vending machine communicates, at Step 700, the result of the determination made at Step 600, the vending machine may also provide a resolution at Step 800. For example, a vending machine may output, on an LCD, a message informing a customer that she is entitled to select either Soda Y or Soda Z in lieu of a previously selected product (e.g. Soda X) that failed to dispense. The customer may in turn select the substitute product, and the vending machine may dispense the substitute product. It should be noted that, in embodiments where customers are provided with products as resolutions to customer service issues, the vending machine and/or controller 205 may be configured to update a product inventory database 125 accordingly (to accurately reflect which products were dispensed).

In embodiments where customers receive compensation codes via user devices (e.g. via email or telephonic communication with controller 205), vending machines may be configured to accept compensation codes and provide resolutions accordingly. In such embodiments, a confirmation subroutine may optionally ensue at Step 800 whereby a vending machine and/or controller 205 compares a compensation code received from a customer to a local or remote database, such as the customer service issue database 140, to determine if the provided compensation code was validly issued and/or if the compensation code was previously redeemed for a resolution. If the compensation code was validly issued and has not previously been redeemed, the vending machine may be configured to provide the corresponding resolution by, for example, dispensing currency and/or dispensing a product.

In some embodiments, the resolution is provided by controller 205, the operator and/or by a CSR. For example, in one embodiment, a CSR mails a refund check to a customer. Or, in another embodiment, a controller 205 credits an account associated with the customer. Further still, in another embodiment, an operator mails a product to a customer.

We claim:

1. A method comprising:
receiving, from a customer, a request for a product to be dispensed by a vending machine, in which the request indicates a first product;
providing a plurality of selectable menu options, each of which defines at least one customer service issue;
receiving, from the customer, a selection of at least one of the menu options, thereby defining an indication of a customer service issue;
determining whether to provide a resolution to the customer service issue; and
providing, to the customer, an offer for a second product that is not the first product.

2. The method of claim 1, in which providing an offer comprises:
providing an offer for one of
the second product, and
a refund.

3. The method of claim 1, in which providing an offer for the second product comprises:
determining that a sales velocity of the second product is less than a threshold.

4. The method of claim 1, in which determining whether to provide a resolution to the customer service issue comprises:
determining whether to provide a resolution to the customer service issue based on sales velocity of the second product.

5. The method of claim 1, further comprising:
determining that the first product is unable to be dispensed from the vending machine; and
disabling the ability to request the first product.

6. A method comprising:
receiving, from a customer, a request for a product to be dispensed by a vending machine, in which the request indicates a first product;
determining that the vending machine has malfunctioned.
providing a plurality of selectable menu options, each of which defines at least one customer service issue;
receiving, from the customer, a selection of at least one of the menu options, thereby defining an indication of a customer service issue;
determining that a sales velocity of a second product is less than a threshold; and
determining whether to provide a resolution to the customer service issue based on the sales velocity; and
providing, to the customer, a compensation code that is redeemable for the second product.

7. A method comprising:
receiving, from a customer, a request for a product to be dispensed by a vending machine;
determining that a customer service issue exists;
determining whether to provide a resolution to the customer service issue; and
providing a resolution to the customer, in which the resolution includes providing an offer for a second product other than a first product indicated by the request.

8. The method of claim 7, in which determining that a customer service issue exists comprises:
receiving, from the customer, an indication of a customer service issue.

9. The method of claim 8, further comprising:
providing a plurality of selectable menu options, each of which defines at least one customer service issue;
and in which
receiving, from the customer, an indication of a customer service issue comprises:
receiving, from the customer, a selection of at least one of the menu options.

10. The method of claim 9, further comprising:
determining diagnostic data of the vending machine; and
determining, based of the diagnostic data, at least one of the plurality of selectable menu options.

11. The method of claim 7, in which determining that a customer service issue exists comprises:
determining that the vending machine has malfunctioned.

12. The method of claim 11, in which
the request includes
an indication of a first product to be dispensed, and in which
determining that the vending machine has malfunctioned comprises:
determining that the vending machine has failed to dispense the first product.

13. The method of claim 12, in which
determining that the vending machine has failed to dispense the first product comprises:
determining that the vending machine has dispensed a product that is not the first product.

14. The method of claim 11, in which
determining that the vending machine has malfunctioned comprises:
determining that the vending machine has not processed payment correctly.

15. The method of claim 14, in which
determining that the vending machine has not processed payment correctly comprises:
determining that the vending machine has not properly credited payment that is tendered by the customer.

16. The method of claim 14, in which
determining that the vending machine has not processed payment correctly comprises:
determining that the vending machine has not properly dispensed payment that is due to the customer.

17. The method of claim 7, further comprising:
determining diagnostic data of the vending machine.

18. The method of claim 17, in which determining diagnostic data of the vending machine comprises at least one of:
assessing data in a database;
receiving an indication of a customer service issue from a customer;
generating an image of at least a portion of the vending machine; and
receiving data from a sensor that is operable to sense a condition of the vending machine.

19. The method of claim 7, in which providing a resolution to the vending machine customer comprises at least one of:
providing to the customer a product other than a product indicated by the request;
providing the customer with money via the vending machine;
establishing a credit balance of the vending machine;
applying credit toward a customer account of the customer;
providing a compensation code to the customer;
providing to the customer a voucher that is redeemable for a benefit from the vending machine;
providing to the customer a voucher that is redeemable for a benefit from another vending machine; and
providing to the customer a voucher that is redeemable for a product from a retail store.

20. The method of claim 7, in which providing an offer for a second product other than a first product indicated by the request comprises:
providing an offer for one of
the second product other than the first product indicated by the request, and a refund.

21. The method of claim 7, in which providing an offer for a second product other than a first product indicated by the request comprises:
determining that a sales velocity of the second product is less than a threshold; and
providing an offer for the second product.

22. The method of claim 7, in which determining whether to provide a resolution to the customer service issue comprises:
determining whether to provide a resolution to the customer service issue based on coin inventory.

23. The method of claim 7, in which determining whether to provide a resolution to the customer service issue comprises:
determining whether to provide a resolution to the customer service issue based on sales velocity of a product.

24. The method of claim 7, further comprising:
determining that a third product is unable to be dispensed from the vending machine; and
disabling the ability of a customer to request the third product.

25. The method of claim 7, further comprising:
recording data associated with the customer service issue; and
determining a unique identifier for the customer service issue.

26. The method of claim 25, further comprising:
determining a resolution based on the recorded data; and
communicating an indication of the determined to the customer.

27. The method of claim 25, further comprising:
receiving information which identifies the customer.

28. The method of claim 25, further comprising:
outputting, to the customer, the unique. Identifier.

29. The method of claim 25, in which outputting, to the customer, the unique identifier comprises:
displaying an alphanumeric code.

30. The method of claim 7, in which recording data associated with the customer service issue comprises:
determining diagnostic data of the vending machine;
recording the diagnostic data.
